(19) United States
(12) Patent Application Publication
(10) Pub. No.: US 2021/0173402 A1
(43) Pub. Date: Jun. 10, 2021

(54) SYSTEMS AND METHODS FOR DETERMINING VEHICLE TRAJECTORIES DIRECTLY FROM DATA INDICATIVE OF HUMAN-DRIVING BEHAVIOR

(71) Applicant: Lyft, Inc., San Francisco, CA (US)

(72) Inventors: Yan Chang, Mountain View, CA (US); Sammy Omari, Los Altos, CA (US); Matthew Swaner Vitelli, San Francisco, CA (US)

(21) Appl. No.: 16/706,307

(22) Filed: Dec. 6, 2019

(51) Int. Cl. G05D 1/02; B60W 40/09; G05D 1/00; G06N 20/10

(52) U.S. Cl. CPC G05D 1/0221; B60W 40/09; G05D 2201/0213; G06N 20/10; G05D 1/0088

(57) ABSTRACT

Examples disclosed herein may involve (i) generating a set of candidate trajectories for a vehicle that each comprise a respective series of planned states for the vehicle, (ii) scoring the candidate trajectories in the generated set of candidate trajectories using one or more reference models that are each configured to (a) receive input values for a respective set of feature variables that are correlated to a respective scoring parameter and (b) output a value for the respective scoring parameter that is reflective of human-driving behavior, (iii) based at least in part on the scoring, selecting a candidate trajectory from the generated set of candidate trajectories to serve as a planned trajectory for vehicle, and (iv) using the selected candidate trajectory as the planned trajectory for the vehicle.

### BACKGROUND

Vehicles are increasingly being equipped with technology that enables them to operate in an autonomous mode in which the vehicles are capable of sensing their surrounding environment and safely driving with little or no human input, as appropriate. For instance, vehicles may be equipped with sensors that are configured to capture data representing the vehicle's surrounding environment, an on-board computing system that is configured to perform various functions that facilitate autonomous operation, including but not limited to localization, object detection, and behavior planning, and actuators that are configured to control the physical behavior of the vehicle, among other possibilities.

### SUMMARY

In one aspect, the disclosed technology may take the form of a method that involves (i) generating a set of candidate trajectories for a vehicle, wherein each candidate trajectory of the set of candidate trajectories comprises a series of planned states for the vehicle, (ii) scoring the candidate trajectories in the generated set of candidate trajectories using one or more reference models that are each configured to (a) receive input values for a respective set of feature variables that are correlated to a respective scoring parameter and (b) output a value for the respective scoring parameter that is reflective of human-driving behavior, (iii) based at least in part on the scoring, selecting a candidate trajectory from the generated set of candidate trajectories to serve as a planned trajectory for vehicle, and (iv) using the selected candidate trajectory as the planned trajectory for the vehicle.

In example embodiments, the function of scoring a respective candidate trajectory in the generated set of candidate trajectories may involve (a) determining expected values for one or more scoring parameters at a plurality of time points along the respective candidate trajectory, (b) determining idealized values for the one or more scoring parameters at the plurality of time points along the respective candidate trajectory, where the one or more reference models are used for the determining of the idealized values for the one or more scoring parameters (c) evaluating an extent to which the expected values for the one or more scoring parameters differ from the idealized values for one or more scoring parameters (e.g., by using one or more cost functions to determine a cost value associated with a difference between the expected values for the one or more scoring parameters and the idealized values for the one or more scoring parameters), and (d) based on the evaluation of the extent to which the expected values for the one or more scoring parameters differ from the idealized values for the one or more scoring parameters, assigning a respective score to the respective candidate trajectory. In such example embodiments, the one or more scoring parameters may also be selected based on a scenario type that is being experienced by the vehicle.

Further, in example embodiments, the method may also involve, before scoring each candidate trajectory in the generated set of candidate trajectories using the one or more reference models, (a) determining a scenario type that is being experienced by the vehicle and (b) using the determined scenario type as a basis for selecting the one or more reference models that are used for the scoring.

Further yet, in example embodiments, each respective reference model of the one or more reference models may be built from data indicative of observed behavior of vehicles being driven by humans. Additionally, in such example embodiments, each respective reference model of the one or more reference models may be built by (a) collecting the data indicative of the observed behavior of the vehicles being driven by humans, (b) extracting model data for building the respective reference model from the collected data, wherein the extracted model data includes (1) values for the respective scoring parameter that were captured for the vehicles being driven by humans at various past times and (2) corresponding values for the respective set of feature variables that were also captured for the vehicles being driven by humans at the past times, and (c) building the respective reference model from the extracted model data, which could involve either (1) embodying the extracted model data into a lookup table having dimensions defined by the respective set of feature variables and cells that are encoded with idealized values for the respective scoring parameter or (2) using one or more machine learning techniques to train machine-learning model based on the extracted model data, among other possibilities.

Still further, in example embodiments, the one or more reference models may comprise at least one blended model that is configured to select between an output of a first sub-model that is reflective of human-driving behavior and an output of a second sub-model that is not reflective of human-driving behavior.

In another aspect, the disclosed technology may take the form of a computing system comprising at least one processor, a non-transitory computer-readable medium, and program instructions stored on the non-transitory computer-readable medium that are executable by the at least one processor such that the computing system is configured to carry out the functions of the aforementioned method.

In yet another aspect, the disclosed technology may take the form of a non-transitory computer-readable medium comprising program instructions stored thereon that are executable to cause a computing system to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIGS. 1A-1B are diagrams that illustrate a vehicle selecting between multiple candidate trajectories in accordance with existing approaches.

FIG. 2 is a diagram that illustrates one possible example of a reference model built from data indicative of human-driving behavior in accordance with the present disclosure.

FIGS. 3A-D are diagrams that illustrate a vehicle using to one possible example of a reference model to select between multiple candidate trajectories in accordance with the present disclosure.

FIG. 4 is a simplified block diagram that illustrates an example embodiment of the learning phase of the present disclosure.

FIG. 5 is a simplified block diagram that illustrates an example embodiment of the runtime phase of the present disclosure.

FIG. 6 is a simplified block diagram that illustrates an example embodiment of a scoring function carried out in accordance with the present disclosure.

FIGS. 7A-C are diagrams that illustrate a vehicle using to another possible example of a reference model to select between multiple candidate trajectories in accordance with the present disclosure.

FIG. 8 is a simplified block diagram that illustrates a networked system arrangement in which example embodiments of a learning phase of the present disclosure may be implemented.

FIG. 9 is a simplified block diagram that illustrates example systems of an example vehicle equipped with autonomous technology.

FIG. 10 is a simplified block diagram that illustrates one example of a ride-services platform.

### DETAILED DESCRIPTION

Vehicles are increasingly being equipped with technology that enables them to evaluate their surrounding environment and then derive potential trajectories for such vehicles to follow, which may then be implemented by the vehicles themselves or presented to drivers in order to assist with the operation of such vehicles. Such vehicles may include vehicles having any of various different levels of autonomous driving capability (e.g., semi- and/or fully-autonomous vehicles) as well as other vehicles equipped with advanced driver assistance systems (ADAS) or other driver assistance systems that are capable of deriving potential vehicle trajectories.

In order to facilitate this functionality, a vehicle may be equipped with an on-board computing system that is generally configured to (i) process and analyze various data related to the vehicle's surrounding environment and its operation therein (e.g., sensor data, map data associated with the vehicle's location, etc.), (ii) derive a behavior plan for the vehicle that defines the desired driving behavior of the vehicle during some future window of time (e.g., over the next 5, 10, 15 seconds, etc.), and then (iii) either generate control signals for executing the derived behavior plan or present the behavior plan to a driver of the vehicle. Notably, the vehicle's on-board computing system typically performs these functions in a repeated manner, such as many times per second, so that the vehicle is able to continually update both its understanding of the surrounding environment and its planned behavior within that surrounding environment.

In practice, a behavior plan that is derived for a vehicle typically includes a planned trajectory for the vehicle, which may take the form of a time-sequence of planned states for the vehicle at several future times (e.g., each second over the next 5 seconds). In this respect, the planned state for the vehicle at each future time may include various types of state information for the vehicle, examples of which may include a planned position of the vehicle at the future time, a planned orientation of the vehicle at the future time, a planned velocity of the vehicle at the future time, and/or a planned acceleration of the vehicle (whether positive or negative) at the future time, among other possibilities.

A vehicle's on-board computing system may determine a planned trajectory for the vehicle in various manners. For instance, as one possibility, a vehicle's on-board computing system may be configured to determine a planned trajectory for the vehicle by (i) generating a plurality of different “candidate” trajectories that could potentially be followed by the vehicle from that point forward, (ii) evaluating the candidate trajectories relative to one another in order to identify which candidate trajectory is most desirable, which generally involves scoring the candidate trajectories using cost functions (or the like) that evaluate certain “scoring parameters” associated with the generated candidate trajectories, and then (iii) selecting the candidate trajectory identified as being most desirable as the planned trajectory for the vehicle. In this respect, the scoring parameters that are used to evaluate the generated candidate trajectories may take various forms, examples of which may include a planned speed of the vehicle at each point along the candidate trajectory, a planned linear and/or lateral acceleration of the vehicle at each point along the candidate trajectory, and/or a proximity to other objects at each point along the candidate trajectory, among other possibilities.

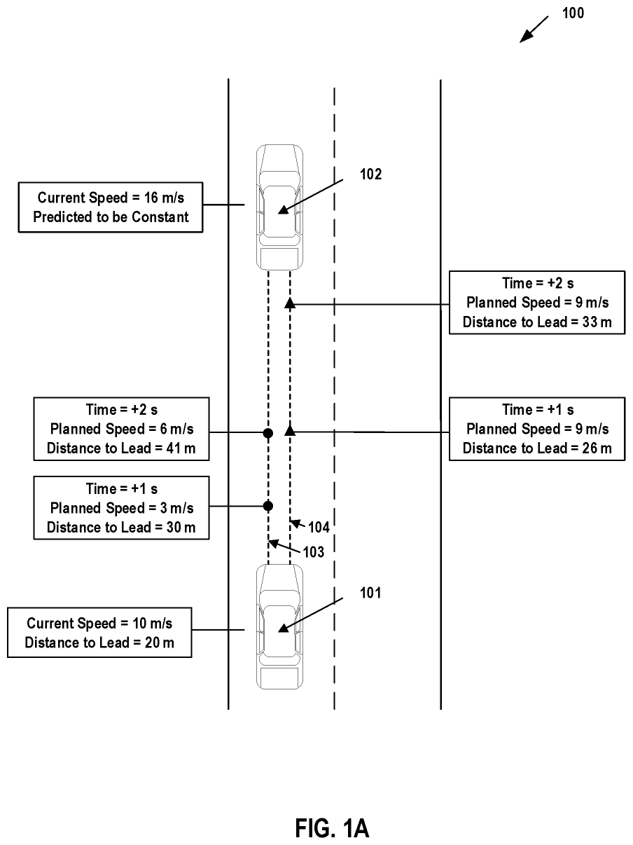

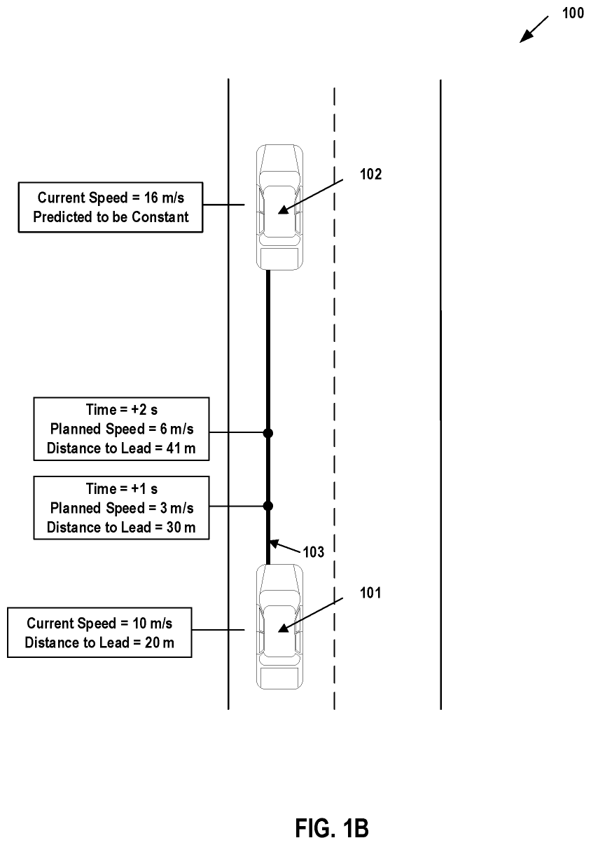

To illustrate this functionality, FIG. 1A is a diagram that depicts a vehicle 101 operating in a real-world environment 100 at a point in time shortly after vehicle 101 has detected that it is following a lead vehicle 102 (e.g., after lead vehicle has moved into the lane of vehicle 101). As shown, at this point in time, vehicle 101 has a current speed of 10 meters per second, lead vehicle 102 has a current speed of 16 meters per second, and the current distance between vehicle 101 and vehicle 102 is 20 meters—which may fall below a minimum distance that is considered to be “desirable” for scenario where a lead vehicle is being followed.

As further shown in FIG. 1A, an on-board computing system of vehicle 101 may function to generate a plurality of candidate trajectories that could potentially be followed by vehicle 101 from this point forward, such as example candidate trajectories 103 and 104, where each such candidate trajectory comprises a different time-sequence of planned states for vehicle 101 over the course of several future times. For instance, candidate trajectory 103 is shown to include (i) a first planned state at a future time of +1 seconds that comprises a planned speed of 3 meters per second and a planned position that places vehicle 101 approximately 30 meters behind lead vehicle 102 (assuming the lead vehicle's speed is predicted to be relatively constant) and (ii) a second planned state at a future time of +2 seconds that comprises a planned speed of 6 meters per second and a planned position that places vehicle 101 approximately 41 meters behind lead vehicle 102. On the other hand, candidate trajectory 104 is shown to include (i) a first planned state at a future time of +1 seconds that comprises a planned speed of 9 meters per second and a planned position that places vehicle 101 approximately 26 meters behind lead vehicle 102 (again assuming the lead vehicle's speed is predicted to be relatively constant) and (ii) a second planned state at a future time of +2 seconds that comprises a planned speed of 9 meters per second and a planned position that places vehicle 101 approximately 33 meters behind lead vehicle 102. (While not shown, it should be understood that the planned accelerations included as part of candidate trajectories 103 and 104 will differ as well, and that the planned states of candidate trajectories 103 and 104 may also differ in other respects).

After generating candidate trajectories 103 and 104, the on-board computing system of vehicle 101 may then evaluate candidate trajectories 103 and 104 relative to one another in order to determine which candidate trajectory is the most desirable, which may involve scoring the candidate trajectories using cost functions (or the like) that evaluate one or more scoring parameters associated with each of candidate trajectories 103 and 104. For instance, in the scenario presented in FIG. 1A, the one or more scoring parameters used to evaluate candidate trajectories 103 and 104 relative to one another may comprise a planned speed of the vehicle at each point along the candidate trajectory (perhaps among other scoring parameters).

Under existing approaches for evaluating candidate trajectories relative to one another, the on-board computing system of vehicle 101 may then determine that, because candidate trajectory 103 results in vehicle 101 increasing its distance from lead vehicle 102 more quickly than candidate trajectory 104 (which is in line with a goal of getting vehicle 101 to a minimum desirable distance from lead vehicle 102), candidate trajectory 103 is the more desirable trajectory and should be selected as the planned trajectory for vehicle 101. FIG. 1B then depicts the result of this determination by showing that candidate trajectory 104 has been discarded and that candidate trajectory 103 is now the planned trajectory for vehicle 101 (shown as a solid line rather than a dotted line as in FIG. 1A). Once selected, the planned trajectory for vehicle 101 could then be implemented by vehicle 101 and/or presented to a driver of vehicle 101, among other possibilities.

While the foregoing functionality generally enables a vehicle to derive a planned trajectory that results in safe vehicle driving behavior, existing approaches for determining which of various candidate trajectories should be used as the planned trajectory for a vehicle may still have limitations. For instance, one such limitation is that the cost functions presently used to evaluate candidate trajectories relative to one another require a significant amount of engineering effort to create. Indeed, in order to develop these cost functions, engineers typically need to evaluate and balance many different scoring parameters associated with candidate trajectories across various different scenarios that could potentially be faced by the vehicle, because the range of desirable values for the different scoring parameters (as well as the relative importance of such scoring parameters) often varies from scenario-to-scenario. As one possible example to illustrate, the range of desirable values for a vehicle's speed may vary depending on whether the vehicle is facing an open road ahead, following a lead vehicle, approaching a stop sign, approaching a turn, changing lanes, or facing some other type of scenario. As a result, development of the cost functions that are presently used to evaluate candidate trajectories relative to one another is a complex engineering task that typically needs to be revisited and refined frequently.

Moreover, another limitation of existing approaches is that the engineered cost functions used to determine which candidate trajectory is most “desirable” typically seek to identify the “optimal” trajectory in a mathematical sense, while giving little or no consideration to how this optimal trajectory will be perceived from the perspective of a human riding in the vehicle. Because of this, existing approaches for determining which candidate trajectory to use as the planned trajectory for a vehicle have the potential to lead to “unnaturalistic” driving behavior that differs from how a human-driven vehicle would typically behave, which may degrade the experience of a human passenger riding in the vehicle. Some examples of this unnatural driving behavior may include unnatural acceleration behavior, unnatural braking behavior, unnatural turning behavior, unnatural lane-change behavior, and/or unnatural behavior when passing other objects in the vehicle's surrounding environment, among other possibilities.

FIGS. 1A-B illustrate one possible example of this type of unnaturalistic driving behavior. For instance, as shown in FIGS. 1A-B and described above, existing approaches for determining which candidate trajectory to use as the planned trajectory for vehicle 101 may result in a determination that candidate trajectory 103 is more desirable than candidate trajectory 104 due to the fact that candidate trajectory 103 results in vehicle 101 increasing its distance from lead vehicle 102 more quickly than candidate trajectory 104. However, if vehicle 101 follows candidate trajectory 103 as its planned trajectory, this will cause vehicle 101 to sharply decelerate from 10 meters per second to 3 meters per second between 0 seconds and +1 seconds and then accelerate from 3 meters per second back to 6 meters per second from +1 seconds and +2 seconds—which is unnaturalistic acceleration behavior that differs from how a human-driven vehicle would behave when faced with this same situation. Thus, even though candidate trajectory 103 was determined to be the most optimal candidate trajectory in a mathematical sense, it may not be the most desirable trajectory from the perspective of a human passenger riding in vehicle 101.

To address these and other problems, disclosed herein is technology for determining a planned trajectory of a vehicle based on data that is indicative of the observed behavior of vehicles being driven by humans (referred to herein as “human-driving behavior”), which may in turn lead to the vehicle engaging in more naturalistic driving behavior that may improve the experience of a human passenger riding in the vehicle.

At a high level, the disclosed technology may include two phases: (i) a “learning” phase and (ii) a “runtime” phase. During the learning phase, data that is indicative of human-driving behavior may be collected, aggregated, and embodied into one or more “reference models” that are each configured to output an “idealized” value for a respective scoring parameter—which is reflective of the value of the respective scoring parameter that would be expected if the vehicle were being driven by a representative human that was being faced with the same scenario. In turn, during the runtime phase, the one or more reference models built during the learning phase may be used to evaluate and select between candidate trajectories for a vehicle.

In accordance with the present disclosure, each reference model that is built from data indicative of human-driving behavior may generally comprise a model that is configured to (i) receive input data associated with a candidate trajectory for a particular set of data variables that have been identified as being correlated to a given scoring parameter, which may be referred to herein as the “feature variables” for the reference model, and then (ii) based on the input data associated with the candidate trajectory for the feature variables, output an idealized value for the given scoring parameter that is reflective of human-driving behavior. Such a reference model may be built for various different types of scoring parameters.

For instance, one possible reference model that may be built from data indicative of human-driving behavior may take the form of a reference model that provides an idealized value of a vehicle's speed at a given point along a candidate trajectory. In this respect, the feature variables that serve as inputs to such a reference model for a vehicle's speed may comprise any data variable that has been identified as having a correlation to the speed of a human-driven vehicle, and examples of such feature variables may include a distance to a lead object and a speed of a lead object, among other possibilities.

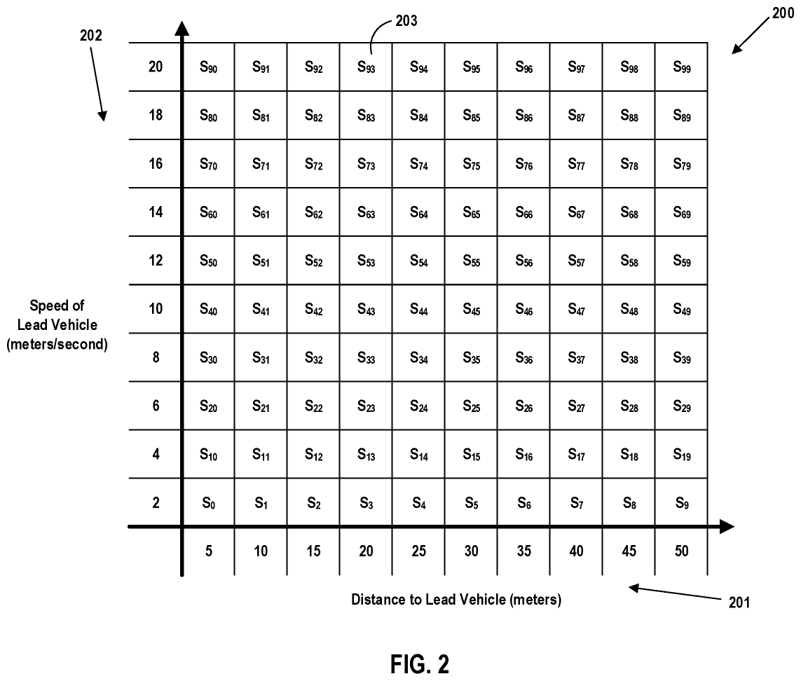

FIG. 2 shows an illustration of one possible example 200 of such a reference model. As shown in FIG. 2, example reference model 200 may be embodied in the form of a lookup table having two dimensions that correspond to two feature variables—a first dimension 201 that corresponds to a distance-to-lead-vehicle variable and a second dimension 202 that corresponds to a speed-of-lead-vehicle variable. In turn, the cells of the lookup table are encoded with idealized values for a vehicle's speed, which have been extracted directly from data indicative of human-driving behavior. For example, as shown in FIG. 2, reference model 200 comprises a cell 203 containing an idealized speed value S₉₃ that corresponds to a distance-to-lead-vehicle of 20 meters and a speed-of-lead-vehicle of 20 meters per second, which is reflective of the fact that actual human-driven vehicles have been observed to have a representative speed value of S₉₃ when facing a scenario in which the human-driven vehicles are 20 meters behind a lead vehicle that is traveling at a speed of 20 meters per second. Likewise, the other cells of reference model 200 contain idealized speed values that are reflective of speed values observed for actual human-driven vehicles that were facing scenarios involving other values for the distance-to-lead-vehicle and a speed-of-lead-vehicle variables.

As described in further detail below, reference models may be built for various other scoring parameters and may be embodied in various other manners as well.

As noted above, after the one or more reference models have been built during the learning phase, such reference models may then be used during a runtime phase to evaluate and select between candidate trajectories for a vehicle, which may be carried out by an on-board computing system of the vehicle (although it is possible that the runtime phase could be carried out by some other computing system that is associated with the vehicle). During this runtime phase, the vehicle's on-board computing system may begin by generating a set of different candidate trajectories for a vehicle at a given point during the vehicle's operation within a real-world environment, and may then score the candidate trajectories in the set using one or more reference models that were built from the data indicative of human-driving behavior.

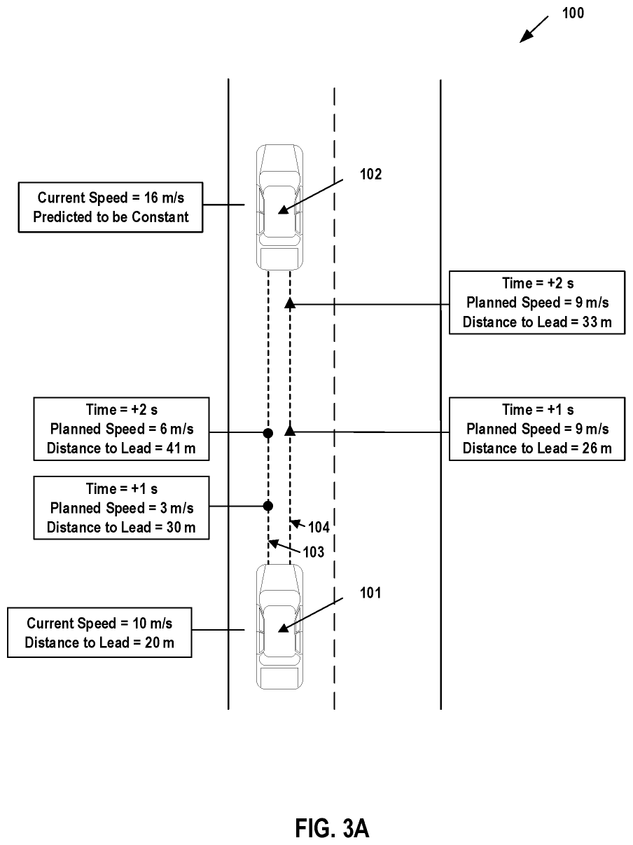

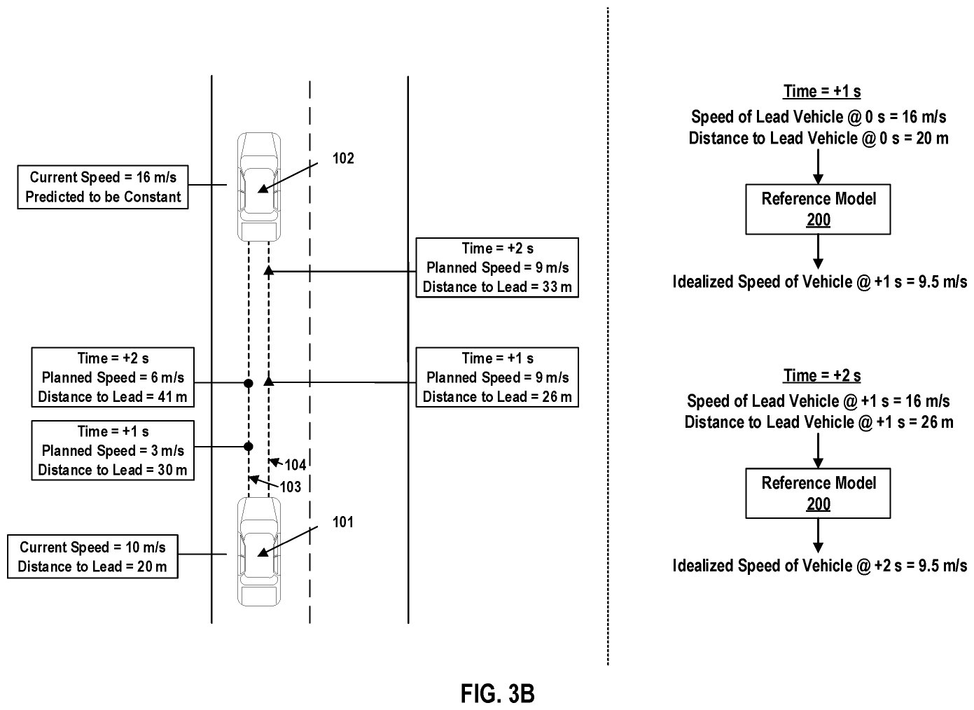

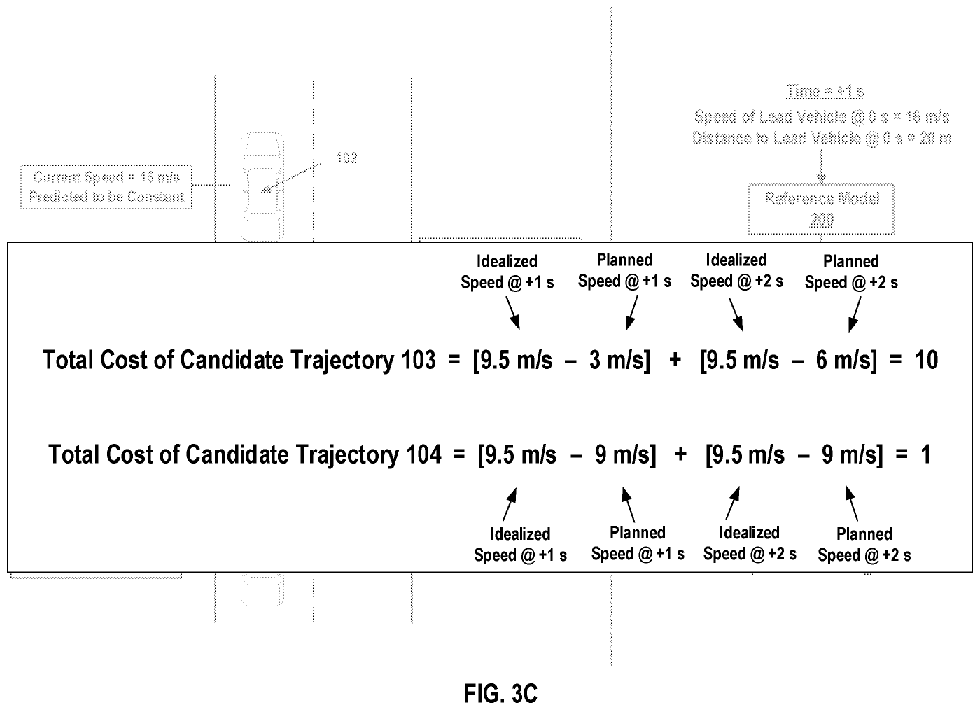

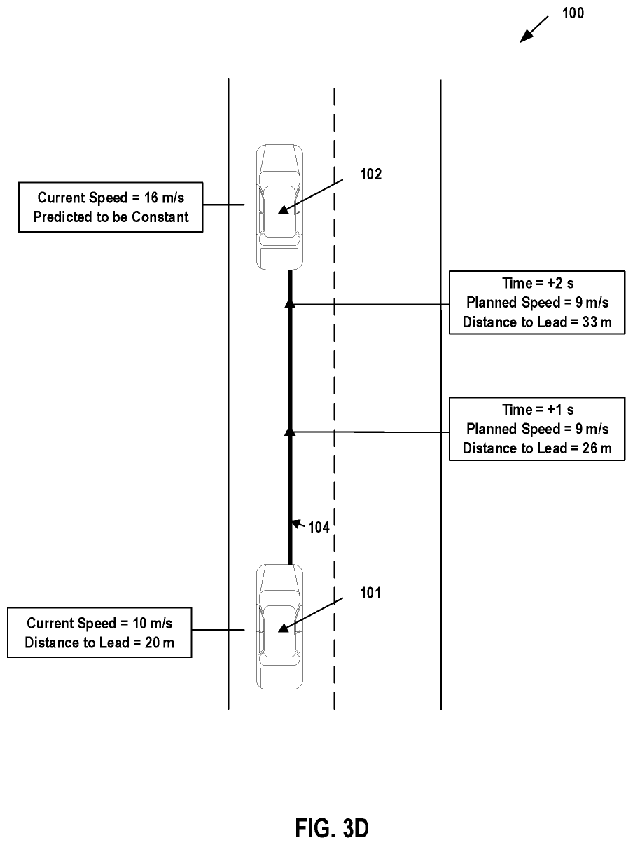

One possible example of how a reference model built from data indicative of human-driving behavior may be used to score candidate trajectories is illustrated in FIGS. 3A-D. As in FIG. 1A, FIG. 3A shows vehicle 101 operating in real-world environment 100 at a point in time shortly after vehicle 101 has detected that it is following a lead vehicle 102, where vehicle 101 has a current speed of 10 meters per second, lead vehicle 102 has a current speed of 16 meters per second, and the current distance between vehicle 101 and vehicle 102 is 20 meters. Further, FIG. 3A shows that on-board computing system of vehicle 101 has generated candidate trajectories 103 and 104, which are identical to candidate trajectories 103 and 104 shown in FIG. 1A.

Once candidate trajectories 103 and 104 have been generated, the vehicle's on-board computing system may then score each of candidate trajectories 103 and 104 using one or more reference models that were previously built from data indicative of human-driving behavior. In this respect, FIG. 3B illustrates how the vehicle's on-board computing system may use example reference model 200 to determine an idealized speed value of vehicle 101 at future times of +1 and +2 seconds, which correspond to the time points along candidate trajectories 103 and 104. For instance, as shown, the vehicle's on-board computing system may use reference model 200 to determine that (i) based on the vehicle's distance-to-lead-vehicle of 20 meters at 0 seconds and the speed-of-lead-vehicle of 16 meters per second at 0 seconds, the idealized speed of vehicle 101 at +1 seconds would be 9 meters per second and (ii) based on the vehicle's predicted distance-to-lead-vehicle of 26 meters at +1 seconds and the predicted speed-of-lead-vehicle of 16 meters per second at +1 seconds, the idealized speed of vehicle 101 at +2 seconds would 9 meters per second. In line with the discussion above, these idealized values output by reference model 200 are reflective of the speed values of vehicle 101 that would be expected at +1 and +2 seconds if vehicle 101 were being driven by a representative human that was being faced with the same scenario presented in FIG. 3A. (Although not shown, it should be understood that the vehicle's on-board computing system may perform a similar operation for any other scoring parameter that may be used to score candidate trajectories 103 and 104 as well).

After using example reference model 200 to determine the idealized speed values of vehicle 101 at the future times of +1 and +2 seconds, the vehicle's on-board computing system may then use a cost function (or the like) to assign a score to each candidate trajectory that reflects a difference between the candidate trajectory's expected values for the speed parameter and the idealized values for the speed parameter that are output by reference model 200. For instance, as shown in FIG. 3C, the vehicle's on-board computing system may use a cost function to determine a respective “cost” value associated with a difference between the expected and idealized values of the vehicle's speed at each time point along candidate trajectories 103 and 104, which may result in (i) candidate trajectory 103 having a cost value of 6.5 at a time of +1 seconds (due to the fact that the planned speed value at +1 seconds differs from the idealized speed value at +1 seconds by 6.5 meters per second) and 3.5 at a time of +1 seconds (due to the fact that the planned speed at +1 seconds differs from the idealized speed at +1 seconds by 3.5 meters per second), and (ii) candidate trajectory 104 having cost values of 0.5 at both +1 seconds and +2 seconds (due to the fact that the planned speed values at +1 and +2 seconds are both 9 meters per second the idealized speed values at +1 seconds and +2 seconds are both 9.5 meters per second). In turn, the vehicle's on-board computing system may aggregate these cost values together in order to determine a “total cost” of candidate trajectories 103 and 104, which may result in a total cost of 10 for candidate trajectory 103 and a total cost of 1 for candidate trajectory 104.

This lower cost value for candidate trajectory 104 is due to the fact that the planned speed values of candidate trajectory 104 are more closely aligned with idealized speed values output by reference model 200 than the planned speed values of candidate trajectory 103, and indicates that candidate trajectory 104 is expected to yield speed behavior that is closer to how a human-driven vehicle would behave. Thus, as long as the candidate trajectories' respective values for any other evaluated scoring parameter are relatively comparable, candidate trajectory 104 would be assigned a better score than candidate trajectory 103.

Once candidate trajectories 103 and 104 have been scored in this manner, the vehicle's on-board computing system may then identify whichever one of candidate trajectories 103 and 104 has the best assigned score and select that identified candidate trajectory as the planned trajectory for vehicle 101. This operation is illustrated in FIG. 3D, which shows that candidate trajectory 104 has been selected as the planned trajectory for vehicle 101 due to the fact that it was assigned the better score after evaluation using reference model 200.

The technology disclosed herein may provide several advantages over existing approaches for determining which of various candidate trajectories should be used as the planned trajectory for a vehicle. First, by making use of references models for scoring parameters that are built directly from data that is indicative of human-driving behavior, the disclosed technology may significantly reduce the amount of engineering effort required to develop the cost functions (or the like) that are used to score candidate trajectories. Second, by engaging in an initial “off-board” process of collecting, aggregating, and embodying data indicative of human-driving behavior into reference models that can then be efficiently applied by a vehicle's on-board computing system during runtime, the disclosed technology may improve the runtime efficiency of on-board computing systems tasked with deriving planned trajectories. Third, by determining the planned trajectories of vehicles based on data that is indicative of human-driving behavior, the disclosed technology may enable vehicles to engage in more naturalistic driving behavior, which may improve the overall experience of human passengers that are riding in such vehicles. The technology disclosed herein may provide various other benefits as well.

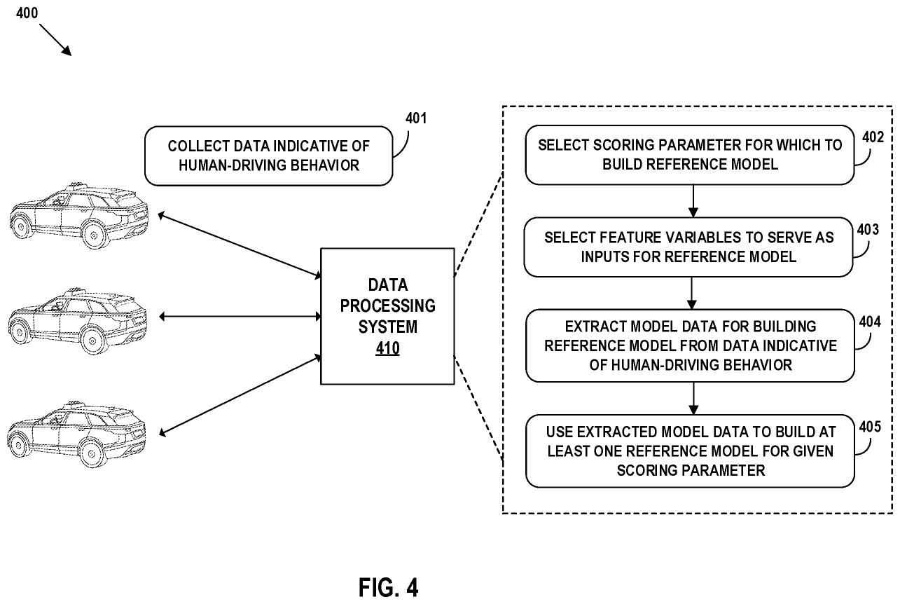

Example embodiments of the disclosed technology for determining a planned trajectory of a vehicle using reference models that are built from data indicative of human-driving behavior will now be described in further detail with reference to FIGS. 4-6. For instance, referring first to FIG. 4, a simplified block diagram 400 is shown that depicts one example embodiment of a learning phase of the disclosed technology, which generally involves using data indicative of human driving behavior to build one or more reference models. For purposes of illustration, the example functions are described as being performed by an example data processing system 410, but it should be understood that another computing system may perform the example functions. Likewise, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

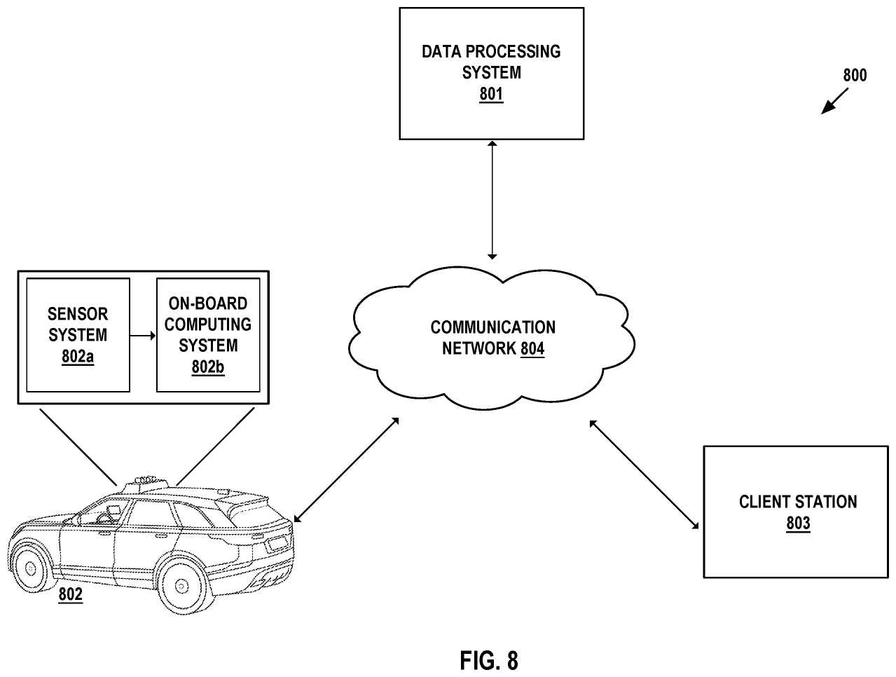

As shown in FIG. 4, the learning phase may begin at block 401 with data processing system 410 collecting data indicative of human-driving behavior. In this respect, data processing system 410 may collect the data indicative of human-driving behavior from various sources. For instance, as shown in FIG. 4, data processing system 410 may collect the data indicative of human-driving behavior from various human-driven collection vehicles. Examples of such human-driven collection vehicles are described in further detail below in connection with FIG. 8. As another possibility, data processing system 410 may collect the data indicative of human-driving behavior from another data processing system (or the like) that has previously collected, processed, and/or otherwise generated the data indicative of human-driving behavior. As yet possibility, data processing system 410 may collect the data indicative of human-driving behavior from a client station. Other sources of the data indicative of human-driving behavior may also exist.

Further, in practice, it should be understood that data processing system 410 may carry out function of collecting the data indicative of human-driving behavior from these sources over the course of some period of time, in which case data processing system 410 may store the obtained data indicative of human-driving behavior in one or more data stores for future use.

Further yet, the obtained data indicative of human-driving behavior may take various forms. In one example, the data indicative of human-driving behavior may include sensor data captured by collection vehicles during times when such collection vehicles are being driven by humans, such as vehicle state data (e.g., position and/or orientation data), two-dimensional (2D) sensor data, and/or three-dimensional (3D) sensor data. In another example, the data indicative of human-driving behavior may include certain data that is derived by the collection vehicles based on captured sensor data. In yet another example, the data indicative of human-driving behavior may include simulated data and/or user-created data that provides an indication of human-driving behavior. The obtained data indicative of human-driving behavior may take other forms as well.

At block 402, data processing system 410 may select a given scoring parameter for which to build a reference model. In this respect, as discussed above, data processing system 410 may select the given scoring parameter from any of a wide range of different scoring parameters that could potentially be used to evaluate candidate trajectories relative to one another (e.g., any parameter that may serve as an input to a cost function used for scoring candidate trajectories), examples of which may include a vehicle's speed at a given time point associated with a candidate trajectory, a vehicle's linear acceleration (whether positive or negative) at a given time point associated with a candidate trajectory, a vehicle's lateral acceleration (whether positive or negative) at a given time point associated with a candidate trajectory, a vehicle's proximity to another object at a given time point associated with a candidate trajectory, a vehicle's lane positioning at a given time point associated with a candidate trajectory, a behavior of a vehicle during a lane change, and/or a vehicle's stop duration, start sequence, and/or speed trajectory when a stop sign is encountered, among other possibilities.

Further, in practice, data processing system 410 may select the given scoring parameter for which to build a reference model in any of various manners, including but not limited to selecting the given scoring parameter based on user input specifying the one or more scoring parameters for which reference models are to be built (which may be received from a client station or the like).

Further yet, while block 402 is directed to selecting one given scoring parameter for which to build a reference model, it should be understood that data processing system 410 may repeat the functions of blocks 402-405 for each of various different scoring parameters.

At block 403, after selecting the given scoring parameter for which to build the reference model, data processing system 410 may then select feature variables that are to serve as inputs for the reference model. In this respect, as discussed above, the selected feature variables for the reference model may comprise any data variable that is identified as having a correlation to the selected scoring parameter (e.g., in the sense that a value of the data variable has a statistical relationship with a value of the scoring parameter), in which case the selected feature variables may vary depending on the selected scoring parameter.

For instance, as one possibility, data processing system 410 may build a reference model from data indicative of human-driving behavior that provides an idealized value of a vehicle's speed at a given time point associated with a candidate trajectory. In this respect, the feature variables that are selected to serve as inputs for such a reference model may comprise any data variable that has been identified as having a correlation to the speed of a human-driven vehicle, and examples of such feature variables may include a distance to a lead object and a speed of a lead object, among other possibilities.

As another possibility, data processing system 410 may build a reference model from data indicative of human-driving behavior that provides an idealized value of a vehicle's linear acceleration (whether positive or negative) at a given time point associated with a candidate trajectory. In this respect, the feature variables that are selected to serve as inputs for such a reference model may comprise any data variable that has been identified as having a correlation to the linear acceleration of a human-driven vehicle, and examples of such feature variables may include a speed of the vehicle, a distance to a lead object, and a speed difference between the vehicle and a lead object, among other possibilities.

As yet another possibility, data processing system 410 may build a reference model from data indicative of human-driving behavior that provides an idealized value of a vehicle's lateral acceleration (whether positive or negative) at a given time point associated with a candidate trajectory. In this respect, the feature variables that are selected to serve as inputs for such a reference model may comprise any data variable that has been identified as having a correlation to the lateral acceleration of a human-driven vehicle, and examples of such feature variables may include a speed of the vehicle, an orientation of the vehicle (e.g., heading), and a geometry of the road ahead of the vehicle, among other possibilities.

As still another possibility, data processing system 410 may build a reference model from data indicative of human-driving behavior that provides an idealized value of a vehicle's proximity to another object at a given time point associated with a candidate trajectory. In this respect, the feature variables that are selected to serve as inputs for such a reference model may comprise any data variable that has been identified as having a correlation to a human-driven vehicle's proximity to another object, and examples of such feature variables may include data variables related to the vehicle's own state, data variables related to the other object's predicted state, and/or data variables related to the road ahead of the vehicle, among other possibilities.

As a further possibility, data processing system 410 may build a reference model from data indicative of human-driving behavior that provides an idealized value of a vehicle's lane positioning at a given time point associated with a candidate trajectory, which may be reflected in terms of the vehicle's cross distance from a center lane and/or the vehicle's cross distance from a lane boundary. In this respect, the feature variables that are selected to serve as inputs for such a reference model may comprise any data variable that has been identified as having a correlation to a human-driven vehicle's lane positioning, and examples of such feature variables may include data variables related to the vehicle's own state, data variables related to the predicted state of objects in proximity to the vehicle, and/or data variables related to the road ahead of the vehicle, among other possibilities.

As yet a further possibility, data processing system 410 may build a reference model from data indicative of human-driving behavior that provides an idealized behavior of a vehicle during a lane change, which may be reflected in terms of an idealized set of spatiotemporal points to be followed during the lane change. In this respect, the feature variables that are selected to serve as inputs for such a reference model may comprise any data variable that has been identified as having a correlation to a human-driven vehicle's behavior during a lane change, and examples of such feature variables may include data variables related to the vehicle's own state, data variables related to the predicted state of objects in proximity to the vehicle, and data variables related to the road ahead of the vehicle, among other possibilities.

As still a further possibility, data processing system 410 may build a reference model from data indicative of human-driving behavior that provides an idealized value of a vehicle's stop duration, start sequence, and/or speed trajectory when a stop sign is encountered. In this respect, the feature variables that serve as inputs to such a reference model may comprise any data variable that has been identified as having a correlation to a human-driven vehicle's behavior when a stop sign is encountered, and examples of such feature variables may include the type of stop sign encountered (e.g., a one-way stop sign versus an all-way stop sign) as well as data variables related to the vehicle's own state, the predicted state of objects in proximity to the vehicle, and the road ahead of the vehicle, among other possibilities.

The feature variables that are selected to serve as inputs for the reference model may also take various other forms. Further, it should be understood that the feature variables may be selected based on user input, data analysis by data processing system 410, or some combination thereof, among other possibilities.

At block 404, once the given scoring parameter and the feature variables have been selected for the reference model, data processing system 410 may then extract model data for building the reference model from the data indicative of human-driving behavior. In this respect, the extracted model data for the reference model may generally comprise (i) values for the given scoring parameter that were captured for human-driven vehicles at various past times and (ii) corresponding values for the selected feature variables that were also captured for the human-driven vehicles at the past times.

For example, if the given scoring parameter is a vehicle's speed at a given time point associated with a candidate trajectory and the selected feature variables include a di stance-to-lead-object variable and speed-of-lead-object variable, the extracted model data for the reference model may comprise (i) speed values that were captured for human-driven vehicles at various past times and (ii) corresponding values for the distance-to-lead-object and speed-of-lead-object variables that were also captured for the human-driven vehicles at the past times. Depending on the given scoring parameter and the corresponding feature variables, the model data may take various other forms as well.

Further, the function of extracting the model data for the reference model from the collected data indicative of human-driving behavior may take various forms, which may depend in part on the model data being extracted. For instance, some scoring parameters and/or feature variables may comprise “raw” or “derived” data variables for which values are already included in the collected data indicative of human-driving behavior, in which case extracting such model data may involve simply accessing the values for these data variables that are already included in the collected data indicative of human-driving behavior. Conversely, others of the scoring parameters and/or feature variables may comprise “derived” data variables for which values are not already included in the collected data indicative of human-driving behavior, in which case extracting such model data may involve deriving the values for these data variables based on the values of other data variables that are included in the data indicative of human-driving behavior.

To illustrate with an example, a vehicle's own speed is a “raw” data variable for which values are likely included in the collected data indicative of human-driving behavior, whereas a distance to a lead vehicle and/or a speed of a lead vehicle are “derived” data variables for which values either may already be included in the obtained data indicative of human-driving behavior (e.g., if previously derived by a collection vehicle based on its captured sensor data) or may need to be derived by data processing system 410 based on other raw data that is included in the collected data indicative of human-driving behavior (e.g., 3D sensor data). Many other examples are possible as well.

Further yet, while extracting the model data for the reference model from the collected data indicative of human-driving behavior, data processing system 410 may apply one or more filters to the data indicative of human-driving behavior in order to exclude certain data from the process of building the reference model. For example, if the given scoring parameter for which the reference model is being built is a vehicle's speed at a given time point associated with a candidate trajectory and the selected feature variables include distance-to-lead-object and speed-of-lead-object variables, data processing system 410 may be configured to apply a filter to the data indicative of human-driving behavior to exclude data associated with human-driven vehicles that had speed values above or below a given threshold, values for the distance-to-lead-object variable that were above or below a given threshold, and/or values for the speed-of-lead-object variable that were above or below a given threshold. Many other examples of filters are possible as well.

Still further, in some implementations, the model data that is extracted for the reference model could be differentiated based on scenario type. For instance, after collecting the data indicative of human-driving behavior, data processing system 410 may be configured to organize and/or label the data indicative of human-driving behavior in terms of which scenario types were being experienced by the human-driven vehicles when such data was captured. In this respect, the data indicative of human-driving behavior could be organized and/or labelled in terms of scenario types such as a “following behind lead vehicle” scenario type, a “turning on a curvature” scenario type, a “shifting position within a lane” scenario type, a “shifting position outside of a lane” scenario type (e.g., to avoid an obstacle), a “changing lanes” scenario type, and/or a “no scenario” scenario type for data that is not associated with any other scenario type, among other possibilities. (It should also be understood that, instead of labeling data in terms of a “no scenario” scenario type, data processing system 410 may simply leave that data unlabeled).

In practice, data processing system 410 can determine which scenario types were being experienced by the human-driven vehicles when the data indicative of human-driving behavior was captured in various manners. For instance, as one possibility, data processing system 410 may make this determination using a machine-learning model that has been trained to predict which one or more scenario types were likely being experienced by vehicles at any given time based on the operational state, identified objects and agents around the vehicle, and any other relevant information obtained. As another possibility, a scenario-type indicator may already be included as a data variable in the data indicative of human-driving behavior (e.g., if the collection vehicle itself was configured to determine scenario type using a machine-learning model or the like), in which case data processing system 410 may use the values for this scenario-type indicator to determine which scenario types were being experienced by the human-driven vehicles when the data indicative of human-driving behavior was captured. Data processing system 410 can determine which scenario types were being experienced by the human-driven vehicles when the data indicative of human-driving behavior was captured in other manners as well.

In turn, when extracting the model data for a given scoring parameter, data processing system 410 may be configured to extract different “scenario-specific” subsets of model data for different scenario types. For example, when extracting the model data for a vehicle's speed, data processing system 410 may be configured to extract a first scenario-specific subset of model data for a “following behind lead vehicle” scenario type, a second scenario-specific subset of model data for a “turning on a curvature” scenario type, and so on. Data processing system 410 may be configured to extract model data for a given scoring parameter that is differentiated based on scenario type in other manners as well, including the possibility that certain scenario types may be grouped together for purposes of extracting the model data for a given scoring parameter (e.g., when extracting the scenario-specific subsets of model data, a single scenario-specific subset of model data could be extracted for two or more related scenario types).

It should also be understood that, in connection with this functionality of differentiating the model data for a given scoring parameter based on scenario type, data processing system 410 could be configured to forgo extracting model data that is associated with certain scenario types. For example, when extracting the model data for a vehicle's speed, data processing system 410 may be configured to forgo extracting model data that is associated with a “no scenario” scenario type and instead only extract model data for the other discrete scenario types.

As discussed in further detail below, this functionality of differentiating the model data for the given scoring parameter based on scenario type may then enable data processing system 410 to derive different “scenario-level” reference models for the given scoring parameter, which may be suitable in circumstances where what is considered to be an “idealized” value for the given scoring parameter could differ depending on scenario type.

Data processing system 410 may extract the model data for the reference model in various other manners as well.

In turn, at block 405, data processing system 410 may use the extracted model data to build at least one reference model for the given scoring parameter that is generally configured to (i) receive input values for the selected feature variables and (ii) output an idealized value for the given scoring parameter that is reflective of human-driving behavior.

For instance, in line with the discussion above, data processing system 410 may be configured to build either (i) a single, “parameter-level” reference model for the given scoring parameter that is configured to provide an idealized value for the given scoring parameter regardless of scenario type or (ii) a set of “scenario-level” reference models for the given scoring parameter that are each configured to provide an idealized value for the given scoring parameter in connection with a particular scenario type (or a particular group of scenario types). In this respect, the extracted model data that is used to build a parameter-level reference model for the given scoring parameter may comprise model data for the given scoring parameter that is associated with all scenario types (or at least all scenario types for which such model data was extracted), whereas the extracted model data that is used to derive a scenario-level reference model for the given scoring parameter may comprise model data for the given scoring parameter that is specifically associated with the scenario type (or the group of scenario types) for which the scenario-level reference model is being built.

These reference models (whether parameter-level or scenario-level) may take various forms and be built in various manners. For instance, in one implementation, a reference model for the given scoring parameter may take the form of a lookup table (or the like) in which the model's feature variables define the dimensions of the lookup table (e.g., the rows, columns, etc.) and the values of the given scoring parameter are encoded within the cells of the lookup table, such that the values of the feature variables may be used to “look up” the corresponding value of the given scoring parameter within the lookup table. In such an implementation, the reference model may be built by organizing and storing the model data for the reference model (e.g., the values for the feature values and corresponding values for the given scoring parameter that are extracted from the data indicative of human-driving behavior) into the lookup table.

One possible example of this type of reference model was previously shown and described with reference to FIG. 2, which depicts a reference model 200 for a vehicle's speed that is embodied in the form of a lookup table having two dimensions corresponding to two feature variables—a first dimension 201 that corresponds to a distance-to-lead-vehicle variable and a second dimension 202 that corresponds to a speed-of-lead-vehicle variable.

In another implementation, a reference model for the given scoring parameter may take the form of a machine-learning model, which may be built by using one or more machine-learning techniques to “train” the model based on the extracted model data for the reference model (e.g., the values for the feature values and corresponding values for the given scoring parameter that are extracted from the data indicative of human-driving behavior). In this respect, the one or more machine-learning techniques used to train such a machine-learning model may take any of various forms, examples of which may include a regression technique, a neural-network technique, a k-Nearest Neighbor (kNN) technique, a decision-tree technique, a support-vector-machines (SVM) technique, a Bayesian technique, an ensemble technique, a clustering technique, an association-rule-learning technique, and/or a dimensionality-reduction technique, among other possibilities.

In yet another implementation, a reference model for the given scoring parameter may take the form of a “blended” model that is configured to determine and output a value for the given scoring parameter based on a combination of (i) a first reference model that is built from data indicative of human-driving behavior and configured to output an idealized value of the given scoring parameter (which may take one of the forms described above) and (ii) a second reference model that is configured to determine an “optimal” value for the given scoring parameter in a mathematical and/or engineering sense. In this respect, the blended model may be configured to determine the value for the given scoring parameter based on this combination of reference models in various manners.

For instance, as one possibility, the blended model may be configured to apply an aggregation function to the respective outputs of the first and second reference models, such as an aggregation function that determines a maximum, minimum, mean, medium, and/or mode of the respective outputs of the first and second reference models.

As another possibility, the blended model may be configured to select between the respective outputs of the first and second reference models based on the values of the feature variables. For instance, the blended model may be configured to use the first reference model's output when the values of the feature variables are within one range and use the second reference model's output when the values of the feature variables are within another range.

As yet another possibility, the blended model may be configured to select between the respective outputs of the first and second reference models based on a determination of which scenario type is being experienced by a vehicle. For instance, the blended model may be configured to use the first reference model's output when a vehicle is experiencing certain scenario types and use the second reference model's output when the values of the feature variables are experiencing certain scenario types.

The blended model may be configured to determine the value for the given scoring parameter based on this combination of reference models in various other manners as well.

It should be understood that such a blended model may be suitable for use in various circumstances, including but not limited to circumstances where there is only a limited amount of human-based model data available for certain data-value ranges or scenario types and/or circumstances where human-driving behavior for certain data-value ranges or scenario types has been deemed to be undesirable for use in defining autonomous driving behavior (e.g., if the human-driven vehicles tend to stay too close to objects when passing).

The one or more reference models disclosed herein may take other forms and/or be built in other manners as well. Further, it should be understood that different forms of reference models may be built for different scoring parameters. For instance, data processing system 410 could build parameter-level reference models for some scoring parameters and scenario-level reference models for other scoring parameters. Further, data processing system 410 could build lookup tables for some scoring parameters, machine-learning models for other scoring parameters, and blended models for still other scoring parameters. Other implementations are also possible. Further yet, it should be understood that data processing system 410 may update the one or more reference models disclosed herein at certain times in the future (e.g., as new data indicative of human-driving behavior becomes available).

While one example embodiment of the disclosed learning phase has been discussed above, it should be understood that disclosed learning phase could take other forms as well.

Once the learning phase is completed, the one or more reference models that are built during the learning phase may then be provided to any computing system that is tasked with carrying out the runtime phase, which will typically comprise on-board computing systems of vehicles but may also include other computing systems (e.g., remote computing systems that are in communication with vehicles). In this respect, data processing system 410 may be configured to provide the one or more reference models to such computing systems in various manners, including by transmitting data defining the one or more reference models to such computing systems via a communication network.

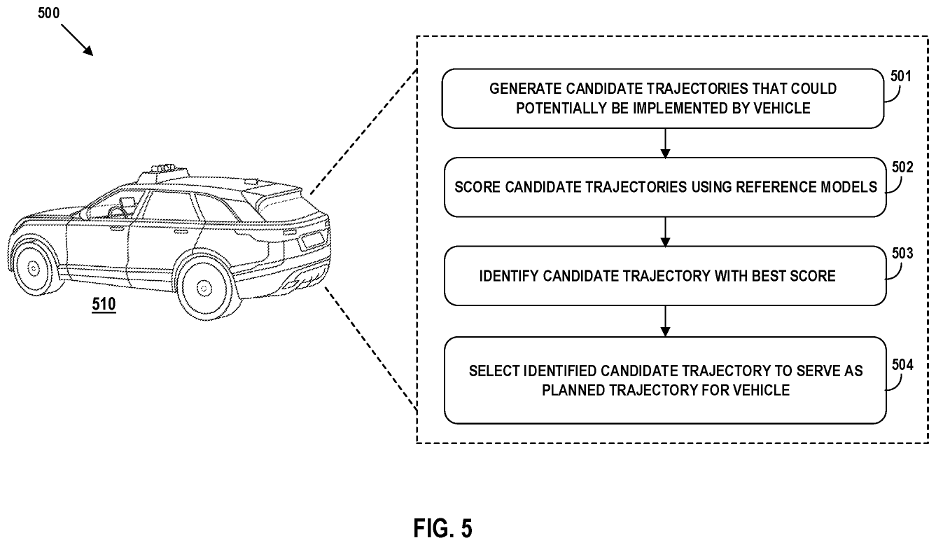

Turning now to FIG. 5, a simplified block diagram 500 is shown that depicts one example embodiment of a runtime phase of the disclosed technology, which generally involves using the one or more reference models built during the learning phase to evaluate and select between candidate trajectories for a vehicle. For purposes of illustration, the example functions are described as being performed by an on-board computing system of example vehicle 510, but it should be understood that the example functions may generally be performed by any computing system that is tasked with determining a planned trajectory for a vehicle. Likewise, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 5, the runtime phase may begin at block 501 with the vehicle's on-board computing system generating a set of different candidate trajectories that could potentially be implemented by vehicle 510 during some future window of time (e.g., over the next 5 seconds). In this respect, as discussed above, each respective candidate trajectory may be defined in terms of a respective time-sequence of planned states for vehicle 510 at several future times (e.g., each second over the next 5 seconds), where each such planned state may include state information such as a planned position, a planned orientation, a planned velocity of vehicle 510, and/or a planned acceleration (whether positive or negative), among other possibilities. However, the data defining the candidate trajectories could take other forms as well, including the possibility that the candidate trajectories may be defined in terms of mathematical expressions rather than time-sequences of planned states.

In practice, the function of generating the candidate trajectories may take various forms. For instance, at a high level, the candidate trajectories may be generated based on data available to the vehicle's on-board computing system that is indicative of the vehicle's surrounding environment and its operation therein, which may include (i) raw data such as sensor data captured by sensors affixed to vehicle 510, map data associated with the vehicle's location, navigation data for vehicle 510 that indicates a specified destination for vehicle 510 (e.g., as input by a user), and/or other types of raw data that provides context for the vehicle's perception of its surrounding environment (e.g., weather data, traffic data, etc.), and/or (ii) data that is derived by the vehicle's on-board computing system based on this raw data, such as derived data indicating a current state of vehicle 510 itself, a class and current state of objects detected in the vehicle's surrounding environment, and/or a predicted future state of objects detected in the vehicle's surrounding environment, among other possibilities.

Further, the candidate trajectories may also be generated based on a set of rules that define certain “baseline” requirements for the candidate trajectories. These rules may take various forms. For instance, one such rule may define requirements regarding minimum distances to other objects in the vehicle's surrounding environment. Another such rule may define requirements regarding the minimum and/or maximum speed of vehicle 510. Yet another such rule may define requirements regarding the maximum linear and/or lateral acceleration of vehicle 510. Still another such rule may define requirements regarding the maximum steering angle of vehicle 510. Another such rule may define requirement regarding the maximum distance vehicle 510 can deviate from the center of a lane. The rules that define the “baseline” requirements for the candidate trajectories may take other forms as well.

Based on the data indicative of the vehicle's surrounding environment and its operation therein as well as the set of rules defining the “baseline” requirements for the candidate trajectories, the vehicle's on-board computing system may then generate a number of different candidate trajectories that each guide vehicle 510 towards its ultimate destination while accounting for the current and future states of the detected objects in the vehicle's surrounding environment in a manner that adheres to the defined “baseline” requirements.

In practice, these generated candidate trajectories may differ from one another in various manners. For example, the generated candidate trajectories may require vehicle 510 to be travelling at different speeds, accelerating and/or decelerating at different rates, executing a turn at different angles, and/or passing objects at different proximities. Generated candidate trajectories may differ from one another in various other manners as well.

The vehicle's on-board computing system may generate the set of candidate trajectories for vehicle 510 in various other manners as well.

In turn, at block 502, the vehicle's on-board computing system may score the candidate trajectories in the generated set using one or more reference models that are built from data indicative of human-driving behavior. This function of scoring the candidate trajectories in the generated set using the one or more reference models may take various forms.

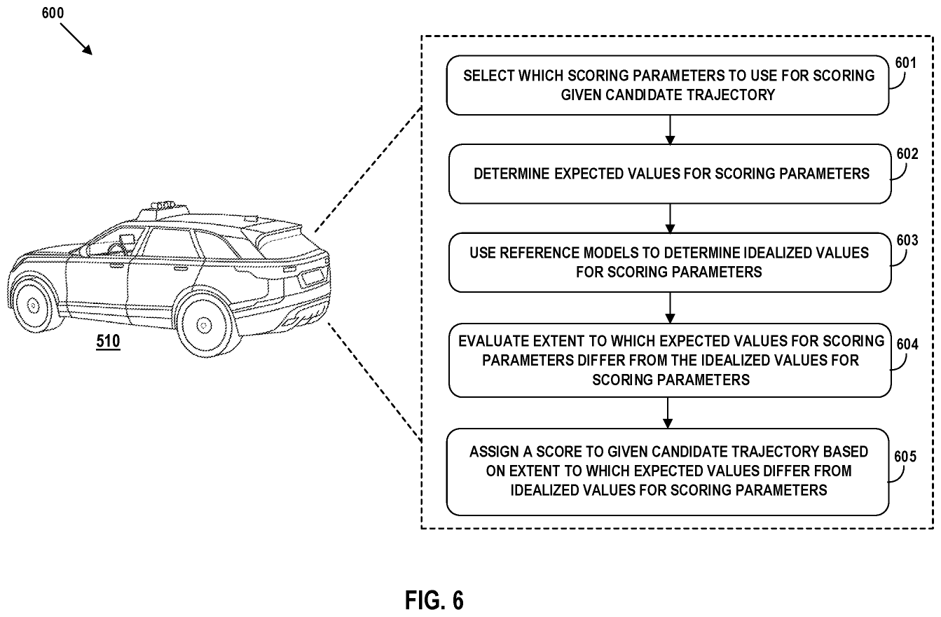

One possible implementation of the scoring function for a given candidate trajectory in the generated set will now be described with reference to FIG. 6, which shows a simplified block diagram 600 that depicts some examples functions that may be included as part of the scoring function. In line with the discussion of FIG. 5, the example functions of FIG. 6 are described as being performed by the on-board computing system of vehicle 510.

As shown in FIG. 6, the scoring function may begin at block 601 with the on-board computing system of vehicle 510 selecting which one or more scoring parameters to use for scoring the given candidate trajectory. This function of selecting the one or more scoring parameters may take various forms.

For instance, as one possibility, the vehicle's on-board computing system may be configured to select the entire universe of available scoring parameters to use for the given candidate trajectory. As another possibility, the vehicle's on-board computing system may be configured to select some subset of available scoring parameters to use for scoring the given candidate trajectory. In this respect, the on-board computing system's selection of which scoring parameters to use for scoring the given candidate trajectory may be based on various factors, one example of which may comprise the scenario type that is currently being experienced by vehicle 510. To illustrate using the example that was previously shown and described above with reference to FIGS. 3A-D, the vehicle's on-board computing system may function to select vehicle speed as a scoring parameter to use for scoring candidate trajectories 103 and 104 based on a determination that vehicle 101 was experiencing a “following behind lead vehicle” scenario type.

The function of selecting the one or more scoring parameters may take other forms as well, including but not limited to the possibility that the scoring parameters to use for scoring candidate trajectories are predefined such that the vehicle's on-board computing system need not make an affirmative selection of the scoring parameters as part of the scoring function.

At block 602, the vehicle's on-board computing system may determine the given candidate trajectory's “expected” values for the selected one or more scoring parameters, which generally comprises the values that the selected one or more scoring parameters are expected to have if vehicle 510 were to implement the given candidate trajectory. In this respect, the expected values that are determined for the given candidate trajectory may vary depending on the type of scoring parameter(s) that are used to score the given candidate trajectory.

For instance, if the selected one or more scoring parameters include a scoring parameter that is to be evaluated on a time-point-by-time-point basis, such as a vehicle's speed, linear acceleration, lateral acceleration, proximity to other objects, and/or lane positioning, then the expected values that are determined for the given candidate trajectory may include a time-sequence of expected values for the scoring parameter at various different time points along the given candidate trajectory (e.g., the different time points included in the time-sequence of planned states for vehicle 510). On the other hand, if the selected one or more scoring parameters include a scoring parameter that is to be evaluated for the given candidate trajectory as a whole, such as a vehicle's lane-change behavior, then the expected values that are determined for the given candidate trajectory may include an expected value for the scoring parameter that applies to the given candidate trajectory as a whole (although it should be understood that this expected value may still be comprised of multiple data elements, such as a set of spatiotemporal points that define a vehicle's lane-change behavior). The expected values that are determined for the given candidate trajectory may take other forms as well.

Further, in practice, the function of determining the given candidate trajectory's expected values for a scoring parameter may take various forms, which may depend in part on the type of scoring parameter being evaluated. For instance, some of the scoring parameters may comprise data variables that are included as part of the data defining the given candidate trajectory, examples of which may include a vehicle's speed, linear and/or lateral acceleration, and lane-change behavior, in which case determining the expected values for such scoring parameters may involve simply accessing the values of such scoring parameters from the data defining the given candidate trajectory. Conversely, others of the scoring parameters may comprise data variables that are not included as part of the data defining the given candidate trajectory, examples of which may include the vehicle's proximity to a next closest object and a vehicle's lane positioning, in which case determining the expected values for such scoring parameters may involve deriving the expected values of such scoring parameters based on the data defining the given candidate trajectory and perhaps also data indicative of the vehicle's surrounding environment (e.g., data indicating predicted future states of detected objects and/or a geometry of the road).

Depending on the type of scoring parameter and the nature of the data defining the given candidate trajectory, the function of determining expected values for a scoring parameter may also involve determining expected values for certain time points along the given candidate trajectory by applying techniques such as extrapolation and/or interpolation to data defining other time points along the given candidate trajectory. For example, if the given candidate trajectory's time-sequence of planned states includes two consecutive time points that comprise respective speeds of 10 meters per second and 9 meters per second, the vehicle's on-board computing system may determine that the expected value of the vehicle's speed at other time points between these two time points by interpolating between the values of 10 meters per second and 9 meters per second. Other examples are possible as well.

The vehicle's on-board computing system may determine the expected values for a scoring parameter in other manners as well.

After determining the expected values for the selected one or more scoring parameters, the vehicle's on-board computing system then embody these expected values into an “expected value dataset” for the given candidate trajectory, which may take various forms. For instance, as one possibility, the expected value dataset for the given candidate trajectory may comprise a set of data arrays that each correspond to one particular time point along the given candidate trajectory and contain the expected values for the entire set of selected scoring parameters at that particular time point along the given candidate trajectory. As another possibility, the expected value dataset for the given candidate trajectory may comprise a set of data arrays that each correspond to one particular scoring parameter in the set of selected scoring parameters and contain the entire set of expected values for that one particular scoring parameter (e.g., the expected values at the various different time points along the given candidate trajectory). The expected value dataset for the given candidate trajectory may take other forms as well.

To illustrate using the example that was previously shown and described above with reference to FIGS. 3A-D, the expected value dataset for candidate trajectory 103 may include expected speed values of 3 meters per second at +1 seconds and 6 meters per second at +2 seconds, while the expected value dataset for candidate trajectory 104 may include expected speed values of 9 meters per second at +1 seconds and 9 meters per second at +2 seconds.

At block 603, the vehicle's on-board computing system may use one or more reference models to determine idealized values for the selected one or more scoring parameters, which generally comprise the values that the selected one or more scoring parameters would be expected to have if vehicle 510 were driven by a human. In this respect, the idealized values that are determined may vary depending on the type of scoring parameter(s) that are used to score the given candidate trajectory.

For instance, if the selected one or more scoring parameters include a scoring parameter that is to be evaluated on a time-point-by-time-point basis, such as a vehicle's speed, linear acceleration, lateral acceleration, proximity to other objects, and/or lane positioning, then the reference model for such a scoring parameter may be used to determine a time-sequence of idealized values for the scoring parameter at various different time points along the given candidate trajectory (e.g., the different time points included in the time-sequence of planned states for vehicle 510). On the other hand, if the selected one or more scoring parameters include a scoring parameter that is to be evaluated for the given candidate trajectory as a whole, such as a vehicle's lane-change behavior, then the reference model for such a scoring parameter may be used to determine an idealized value for the scoring parameter that applies to the given candidate trajectory as a whole (although it should be understood that this idealized value may still be comprised of multiple data elements, such as a set of spatiotemporal points that define an idealized lane-change behavior for a vehicle). The idealized values that are determined for the selected one or more scoring parameters using the one or more reference models may take other forms as well.

Further, in practice, the function of using a reference model to determine a set of idealized values for a given scoring parameter at various time points along the given candidate trajectory may involve, for each respective time point along the given candidate trajectory, (i) determining values for the reference model's feature variables, (ii) inputting the determined values into the reference model, and (iii) designating the value output by the reference model as an idealized value for the given scoring parameter (which may could apply to a particular time point along the given candidate trajectory or to the given candidate trajectory as a whole). In this respect, the vehicle's on-board computing system may determine values for the reference model's feature variables based on various data, examples of which may include data indicating a current state of the vehicle, data indicating a current state of objects detected in the vehicle's surrounding environment, data indicating a predicted future state of objects detected in the vehicle's surrounding environment, and/or data defining the given candidate trajectory, among other possibilities.

To illustrate using the example that was previously shown and described above with reference to FIGS. 3A-D, the vehicle's on-board computing system may function to use example reference model 200 to determine idealized speed values for vehicle 101 at the different times along candidate trajectories 103 and 104 by (i) inputting values for the distance-to-lead-object and speed-of-lead-object feature variables at a time of 0 seconds into reference model 200 in order to determine an idealized speed value for vehicle 101 at a time of +1 seconds and (ii) inputting values for the distance-to-lead-object and speed-of-lead-object feature variables at a time of +1 seconds into reference model 200 in order to determine an idealized speed value for vehicle 101 at a time of +2 seconds. As shown in FIG. 3B, this functionality may result in the vehicle's on-board computing system determining that the idealized speed values for vehicle 101 are 9.5 meters per second at +1 seconds and 9.5 meters per second at +2 seconds.

In line with the discussion above, it is also possible that in some embodiments, the vehicle's on-board computing system may have multiple scenario-level reference models for a given scoring parameter. In such embodiments, the function of using a reference model to determine idealized values for a given scoring parameter at various time points along the given candidate trajectory may then involve a preliminary step of selecting which of the scoring parameter's scenario-level reference models to use in order to determine the idealized values for the given scoring parameter, which may take various forms. For instance, the vehicle's on-board computing system may be configured to (i) determine which scenario type is currently being experienced by the vehicle (e.g., by evaluating data indicative of the vehicle's surrounding environment using a machine-learning model or the like) and then (ii) select the scenario-level reference model for the scoring parameter that corresponds to the determined scenario type.

The function of using the one or more reference models to determine the idealized values for a scoring parameter may take other forms as well.

At block 604, the vehicle's on-board computing system may evaluate an extent to which the given candidate trajectory's expected values for the selected one or more scoring parameters differ from the idealized values for the selected one or more scoring parameters. At a high level, this function of evaluating the extent to which the given candidate trajectory's expected values for the selected one or more scoring parameters differ from the idealized values for the selected one or more scoring parameters may involve the use of cost functions, which may take various forms.

For instance, in one implementation, the vehicle's on-board computing system may be configured to use parameter-specific cost functions that are each configured to output a “cost” value associated with a difference between the expected and idealized values for one particular scoring parameter at a one particular time point along the given candidate trajectory. In such an implementation, the vehicle's on-board computing system may be configured apply the respective parameter-specific cost function for each selected scoring parameter at each different time point along the given candidate trajectory, which may result in a respective set of parameter-specific cost values for each time point along the given candidate trajectory. In turn, the vehicle's on-board computing system may aggregate these cost values together in order to determine a “total cost” of the given candidate trajectory. On-board computing system may perform this aggregation in various manners.

As one possibility, the vehicle's on-board computing system may first aggregate the individual cost values on a time point-by-point basis across all selected scoring parameters, which may produce an aggregated cost value for each time point along the given candidate trajectory, and may then aggregate these aggregated cost values across all of the time points of the given candidate trajectory in order to obtain the total cost of the given candidate trajectory. As another possibility, the vehicle's on-board computing system may first aggregate the individual cost values on a parameter-by-parameter basis across all time points, which may produce an aggregated cost value for each selected scoring parameter, and may then aggregate these aggregated cost values across of all the selected scoring parameters in order to obtain the total cost of the given candidate trajectory. The vehicle's on-board computing system may aggregate the set of parameter-specific cost values to determine a total cost of the given candidate trajectory in other manners as well. Further, it should be understood that the aggregation function used by the vehicle's on-board computing system may also be considered a cost function.

In another implementation, the vehicle's on-board computing system may be configured to use cost functions that are each configured to output a “cost” value associated with a difference between the expected and idealized values for the entire set of selected scoring parameters at one particular time point along the given candidate trajectory. In this implementation, the vehicle's on-board computing system may be configured to apply the cost function at each different time point along the given candidate trajectory, which may result in a respective cost value for each time point along the given candidate trajectory. In turn, the vehicle's on-board computing system may aggregate these cost values together across all of the time points of the given candidate trajectory in order to determine a total cost of the given candidate trajectory.

To illustrate the foregoing using the example that was previously shown and described above with reference to FIGS. 3A-D, the vehicle's on-board computing system may use a speed-specific cost function to determine a respective “cost” value associated with a difference between the expected and idealized values of the vehicle's speed at each time point along candidate trajectories 103 and 104, which may result in (i) candidate trajectory 103 having a cost value of 6.5 at a time of +1 seconds (due to the fact that the planned speed value at +1 seconds differs from the idealized speed value at +1 seconds by 6.5 meters per second) and 3.5 at a time of +1 seconds (due to the fact that the planned speed at +1 seconds differs from the idealized speed at +1 seconds by 3.5 meters per second), and (ii) candidate trajectory 104 having cost values of 0.5 at both +1 seconds and +2 seconds (due to the fact that the planned speed values at +1 and +2 seconds are both 9 meters per second the idealized speed values at +1 seconds and +2 seconds are both 9.5 meters per second). In turn, the vehicle's on-board computing system may aggregate these cost values together in order to determine a “total cost” of candidate trajectories 103 and 104, which may result in a total cost of 10 for candidate trajectory 103 and a total cost of 1 for candidate trajectory 104 (thereby indicating that candidate trajectory 104 is expected to yield driving behavior that is closer to how a human-driven vehicle would behave).

Other ways to evaluate the extent to which the given candidate trajectory's expected values for the selected one or more scoring parameters differ from the idealized values for the selected one or more scoring parameters may exist as well.

At block 605, based on the evaluation of the extent to which the given candidate trajectory's expected values for the selected one or more scoring parameters differ from the idealized values for the selected one or more scoring parameters, the vehicle's on-board computing system may assign a score to the given candidate trajectory that represents the extent to which the given candidate trajectory's expected values differ from the idealized values for the selected one or more scoring parameters. Such a score may be assigned in various manners and take various forms.

For instance, as one possibility, the score could be the total cost of the given candidate trajectory as discussed above with respect to block 604, in which case a lower score value would be deemed more desirable (because it reflects a less divergence from the idealized values) and a higher score would be deemed less desirable (because it reflects a greater divergence from the idealized values). To illustrate using the example that was previously shown and described above with reference to FIGS. 3A-D, the score assigned to candidate trajectory 103 could be 10 (which is the total cost determined as described above) while the score assigned to candidate trajectory 104 could be 1 (which is the total cost determined as described above), in which case candidate trajectory 104 may be deemed more desirable than candidate trajectory 103.

As another possibility, the score could be another value that is derived based on the total cost of the given candidate trajectory, including scores for which a higher score value would be deemed more desirable and a lower score would be deemed less desirable. The score may be assigned in other manners and take other forms as well.

Returning to FIG. 5, at block 503, the vehicle's on-board computing system may identify whichever one of the scored candidate trajectories in the generated set has the best assigned score (which may either be the lowest score or the highest score, depending on the implementation). In turn, at block 504, the vehicle's on-board computing system may select the identified candidate trajectory to serve as the planned trajectory for the vehicle from that point forward.

Once the vehicle's on-board computing system selects the identified candidate trajectory to serve as the planned trajectory for vehicle 510, then in line with the discussion above, the vehicle's on-board computing system may implement the planned trajectory (e.g., by generating control signals for causing the vehicle's physical operation to change) and/or present the planned trajectory to a driver of vehicle 510, among other possibilities.

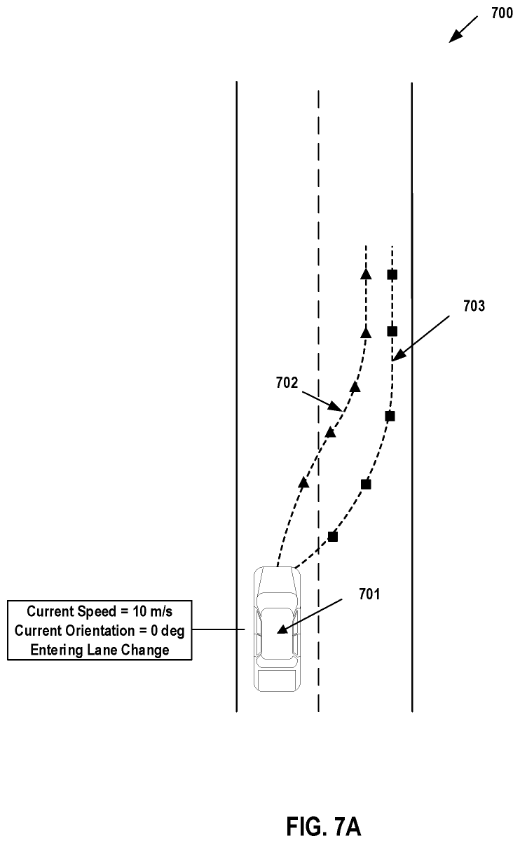

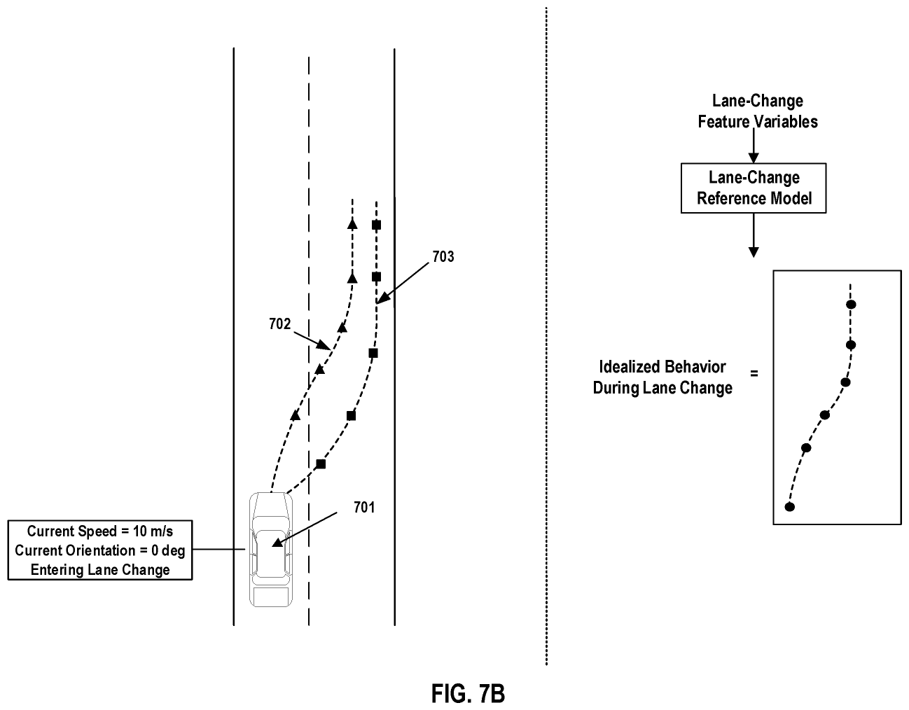

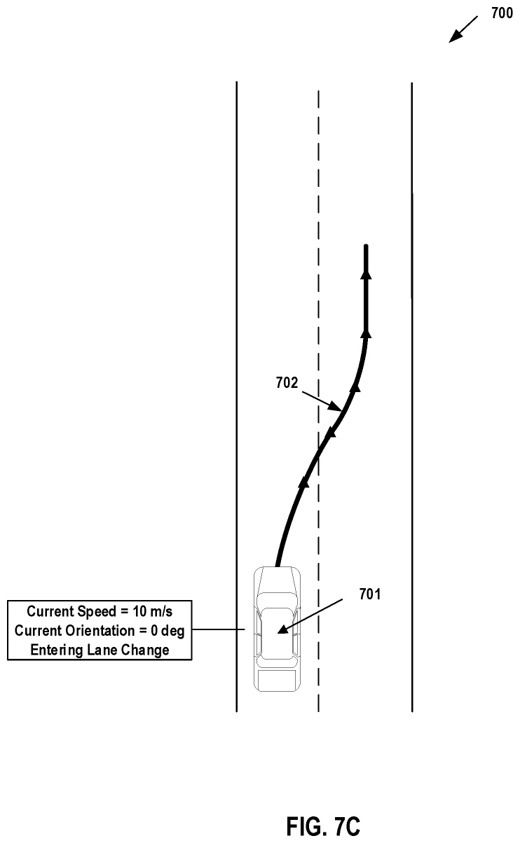

Another illustrative example of how a reference model built from data indicative of human-driving behavior may be used to score a candidate trajectory will now be described with reference to FIGS. 7A-C. Beginning with FIG. 7A, an example vehicle 701 is shown operating in a real-world environment 700 at a point in time when vehicle 701 is about to undertake a lane change while having a current speed of 10 meters per second and a current orientation of 0 degrees (i.e., true north). Further, FIG. 7A shows that on-board computing system of vehicle 701 has generated at least two candidate trajectories 702 and 703 that define the vehicle's behavior for carrying out the lane change.

Once candidate trajectories 702 and 703 have been generated, the vehicle's on-board computing system may then score each of candidate trajectories 702 and 703 using a reference model built from data indicative of human-driving behavior that provides an idealized lane-change behavior for a vehicle. In this respect, FIG. 7B illustrates how the vehicle's on-board computing system may use such a reference model to determine an idealized lane-change behavior of vehicle 701. As shown in FIG. 7B, the vehicle's on-board computing system may input values for a set of lane-change feature variables (e.g., data variables related to the current state of vehicle 702 and/or the road ahead of vehicle 702) into such a lane-change reference model, which may in turn output an idealized set of spatiotemporal points that define an idealized lane-change behavior for vehicle 701. In line with the discussion above, this idealized lane-change behavior output by the lane-change reference model is reflective of the lane-change behavior that would be expected if vehicle 701 were being driven by a representative human that was being faced with the same scenario presented in FIG. 7A.

After using the lane-change reference model to determine an idealized lane-change behavior of vehicle 701, the vehicle's on-board computing system may then use a cost function (or the like) to assign a score to each candidate trajectory that reflects a difference between the candidate trajectory's planned lane-change behavior and the idealized lane-change behavior determined using the reference model. In this respect, the score assigned each of candidate trajectories 702 and 703 will reflect the extent to which each candidate trajectory's planned lane-change behavior differs from the idealized lane-change behavior of vehicle 701, and as shown in FIG. 7B, the planned set of spatiotemporal points included in candidate trajectory 702 are more closely in line with the idealized set of spatiotemporal points output by the lane-change reference model than the planned set of spatiotemporal points for candidate trajectory 703. Thus, as long as the candidate trajectories' respective values for any other evaluated scoring parameter are relatively comparable, candidate trajectory 702 would be assigned a better score than candidate trajectory 703.

Once candidate trajectories 702 and 703 have been scored in this manner, the vehicle's on-board computing system may then identify whichever one of candidate trajectories 702 and 703 has the best assigned score and select that identified candidate trajectory as the planned trajectory for vehicle 701. This operation is illustrated in FIG. 7C, which shows that candidate trajectory 702 has been selected as the planned trajectory for vehicle 701 due to the fact that it was assigned the better score after evaluation using a lane-change reference model—which generally indicates that candidate trajectory 702 is expected to yield driving behavior that is closer to how a human-driven vehicle would behave when undertaking a lane change.

Turning now to FIG. 8, a simplified block diagram is provided to illustrate one example of a networked system arrangement 800 in which example embodiments of the learning phase that is described above may be implemented. As shown, networked system arrangement 800 may include a data processing system 801 (which may be serve as data processing system 410 described above) that may be communicatively coupled to at least one collection vehicle 802 and at least one client station 803 via one or more communication networks 804.

Broadly speaking, data processing system 801 may include one or more computing systems that collectively comprise a communication interface, a processor, data storage, and executable program instructions for carrying out functions related to the learning phase of the present disclosure, which generally involves using data indicative of human-driving behavior derive reference models for a set of scoring parameters. These one or more computing systems of data processing system 801 may take various forms and be arranged in various manners.

For instance, as one possibility, data processing system 801 may comprise computing infrastructure of a public, private, and/or hybrid cloud (e.g., computing and/or storage clusters) that has been provisioned with software for carrying out one or more of the learning-phase functions disclosed herein. In this respect, the entity that owns and operates data processing system 801 may either supply its own cloud infrastructure or may obtain the cloud infrastructure from a third-party provider of “on demand” computing resources, such as Amazon Web Services (AWS), Microsoft Azure, Google Cloud, Alibaba Cloud, or the like. As another possibility, data processing system 801 may comprise one or more dedicated servers that have been provisioned with software for carrying out one or more of the learning-phase functions disclosed herein. Other implementations of data processing system 801 are possible as well.

As noted above, data processing system 801 may be communicatively coupled to at least one collection vehicle 802, which may generally comprise any vehicle that is capable of collecting data while operating in a real-world environment. In accordance with the present disclosure, collection vehicle 802 may primarily be operated a human driver, although it is possible that collection vehicle 802 could also be equipped with autonomous technology that enables collection vehicle 802 to operate autonomously. Either way, as shown, collection vehicle 802 may include at least a sensor system 802a that is configured capture sensor data related to the collection vehicle's operation within a real-world environment and an on-board computing system 802b that is generally configured to perform functions related to processing and distributing data related to the collection vehicle's operation within the real-world environment (among other possible functions). Each of these collection-vehicle systems may take various forms.

For instance, sensor system 802a may generally comprise an arrangement of one or more different types of sensors that are affixed to collection vehicle 802 and configured to capture sensor data related to the collection vehicle's operation within a real-world environment. For example, sensor system 802a may include 2D sensors (e.g., a 2D camera array), 3D sensors (e.g., a Light Detection and Ranging (LIDAR) unit, Radio Detection and Ranging (RADAR) unit, Sound Navigation and Ranging (SONAR) unit, or the like), an Inertial Measurement Unit (IMU), an Inertial Navigation System (INS), and/or a Global Navigation Satellite System (GNSS) unit such as a Global Positioning System (GPS) unit, among other possibilities. Sensor system 802a may include other types of sensors as well.

In turn, on-board computing system 802b of collection vehicle 802 may generally comprise any computing system that includes at least a communication interface, a processor, and data storage, where such components may either be part of a single physical computing device or be distributed across a plurality of physical computing devices that are interconnected together via a communication link. Each of these components may take various forms.

For instance, the communication interface of on-board computing system 802b may take the form of any one or more interfaces that facilitate communication with other systems of collection vehicle 802 (e.g., sensor system 802a), data processing system 801, as well as other remote computing systems, among other possibilities. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols.

Further, the processor of on-board computing system 802b may comprise one or more processor components, each of which may take the form of a general-purpose processor (e.g., a microprocessor), a special-purpose processor (e.g., an application-specific integrated circuit, a digital signal processor, a graphics processing unit, a vision processing unit, etc.), a programmable logic device (e.g., a field-programmable gate array), or a controller (e.g., a microcontroller), among other possibilities.

Further yet, the data storage of on-board computing system 802b may comprise one or more non-transitory computer-readable mediums, each of which may take the form of a volatile medium (e.g., random-access memory, a register, a cache, a buffer, etc.) or a non-volatile medium (e.g., read-only memory, a hard-disk drive, a solid-state drive, flash memory, an optical disk, etc.), and these one or more non-transitory computer-readable mediums may be capable of storing both (i) program instructions that are executable by the processor of on-board computing system 802b such that on-board computing system 802b is configured to perform various functions related to processing and distributing data related to the collection vehicle's driving behavior within the real-world environment (among other possible functions), and (ii) data that may be received, derived, or otherwise stored by on-board computing system 802b.

For instance, in accordance with the present disclosure, the data storage of on-board computing system 802b may be provisioned with program instructions that that are executable by the processor of on-board computing system 802b such that on-board computing system 802b is configured to (i) receive sensor data that was captured by collection vehicle's sensor system 802a while collection vehicle 802 was being operated by a human driver in a real-world environment, (ii) perform various processing on the received sensor data, including transforming and/or arranging the received sensor data into a form suitable for transmission to other computing systems and perhaps also generating other derived data based on the received sensor data, and (iii) cause the processed sensor data (which may include derived data) to be transmitted to data processing system 801 via the communication interface of on-board computing system 802b. However, the program instructions stored in the data storage of on-board computing system 802b may take various other forms as well.

As shown in FIG. 8, data processing system 801 also may be communicatively coupled to at least one client station 803, which may generally comprise any computing device that is configured to facilitate user interaction with data processing system 801. For instance, client station 803 may take the form of a desktop computer, a laptop, a netbook, a tablet, a smartphone, and/or a personal digital assistant (PDA), among other possibilities, where each such device may comprise an input/output (I/O) interface, a communication interface, a processor, data storage, and executable program instructions for facilitating user interaction with data processing system 801. In this respect, the user interaction that may take place with data processing system 801 in accordance with the present disclosure may take various forms, examples of which may include inputting and/or reviewing data indicative of human-driving behavior that may be used by data processing system 801 to derive reference models.

As discussed above, data processing system 801 may be communicatively coupled to collection vehicle 802 and client station 803 via communication network 804, which may take various forms. For instance, at a high level, communication network 804 may include one or more Wide-Area Networks (WANs) (e.g., the Internet or a cellular network), Local-Area Networks (LANs), and/or Personal Area Networks (PANs), where each such network which may be wired and/or wireless and may carry data according to any of various different communication protocols. Further, it should be understood that the respective communications paths between the system entities of FIG. 4 may take other forms as well, including the possibility that such communication paths include communication links and/or intermediate devices that are not shown.

It should be understood that system arrangement 800 may include various other entities and various other forms as well.

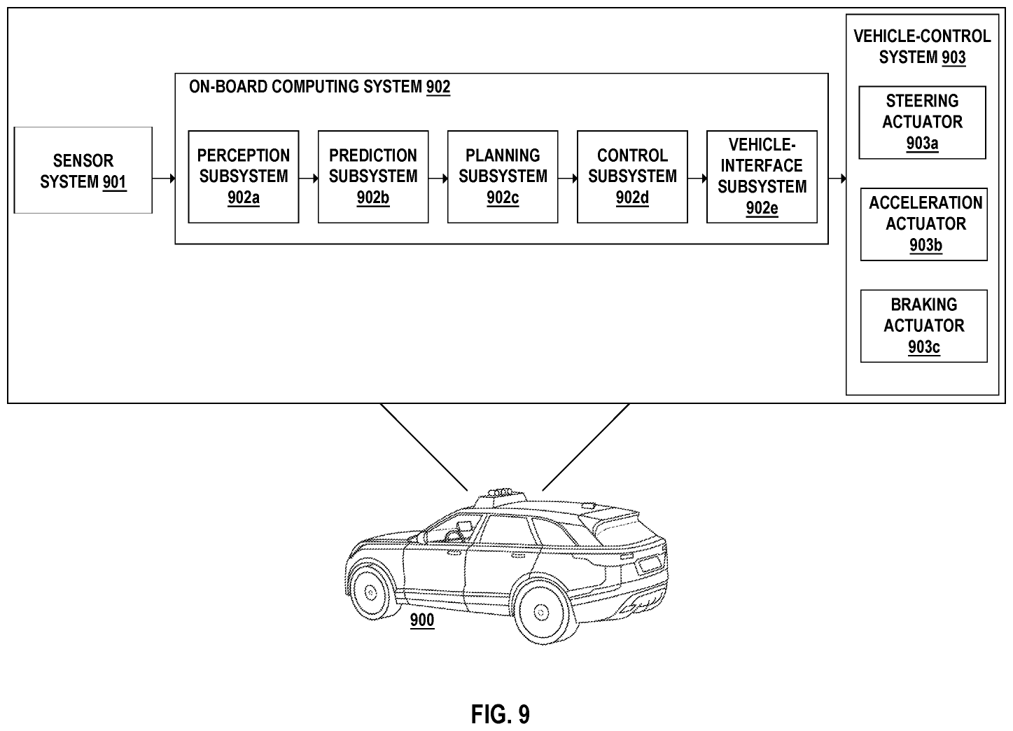

Turning now to FIG. 9, a simplified block diagram is provided to illustrate certain systems that may be included in an example vehicle 900 that is capable of operating autonomously (which could be serve as vehicle 510 described above). As shown, at a high level, vehicle 900 may include at least a (i) sensor system 901 that is configured capture sensor data that is representative of the real-world environment being perceived by the vehicle (i.e., the vehicle's “surrounding environment”) and/or the vehicle's operation within that real-world environment, (ii) an on-board computing system 902 that is configured to perform functions related to autonomous operation of vehicle 900 (and perhaps other functions as well), and (iii) a vehicle-control system 903 that is configured to control the physical operation of vehicle 900, among other possibilities. Each of these systems may take various forms.

In general, sensor system 901 may comprise an arrangement of one or more different types of sensors that are affixed to vehicle 900 and configured to capture sensor data related to the vehicle's operation within a real-world environment. For example, similar to sensor system 802a of collection vehicle 802, sensor system 901 may include 2D sensors (e.g., a 2D camera array), 3D sensors (e.g., a LIDAR unit, RADAR unit, SONAR unit, or the like), an IMU, an INS, and/or a GNSS unit such as a GPS unit, among other possibilities. Sensor system 901 may include other types of sensors as well.

In turn, on-board computing system 902 may generally comprise any computing system that includes at least a communication interface, a processor, and data storage, where such components may either be part of a single physical computing device or be distributed across a plurality of physical computing devices that are interconnected together via a communication link. Each of these components may be similar in form to that of the components of on-board computing system 802b of collection vehicle 802 described above.

For instance, the communication interface of on-board computing system 902 may take the form of any one or more interfaces that facilitate communication with other systems of vehicle 900 (e.g., sensor system 901, vehicle-control system 903, etc.) and/or remote computing systems (e.g., a ride-services management system), among other possibilities. In this respect, each such interface may be wired and/or wireless and may communicate according to any of various communication protocols, including but not limited to the communication protocols described above. Further, the processor of on-board computing system 902 may comprise one or more processor components, each of which may take any of the forms described above and these one or more non-transitory computer-readable mediums may be capable of storing both (i) program instructions that are executable by the processor of on-board computing system 902 such that on-board computing system 902 is configured to perform various functions related to the autonomous operation of vehicle 900 (among other possible functions), and (ii) data that may be obtained, derived, or otherwise stored by on-board computing system 902.

In one embodiment, on-board computing system 902 may also be functionally configured into a number of different subsystems that are each tasked with performing a specific subset of functions that facilitate the autonomous operation of vehicle 900, and these subsystems may be collectively referred to as the vehicle's “autonomy system.” In practice, each of these subsystems may be implemented in the form of program instructions that are stored in the on-board computing system's data storage and are executable by the on-board computing system's processor to carry out the subsystem's specific subset of functions, although other implementations are possible as well—including the possibility that different subsystems could be implemented via different hardware components of on-board computing system 902.

As shown in FIG. 9, in one embodiment, the functional subsystems of on-board computing system 902 may include (i) a perception subsystem 902a that generally functions to derive a representation of the surrounding environment being perceived by vehicle 900, (ii) a prediction subsystem 902b that generally functions to predict the future state of each object detected in the vehicle's surrounding environment, (iii) a planning subsystem 902c that generally functions to derive a behavior plan for vehicle 900, (iv) a control subsystem 902d that generally functions to transform the behavior plan for vehicle 900 into control signals for causing vehicle 900 to execute the behavior plan, and (v) a vehicle-interface subsystem 902e that generally functions to translate the control signals into a format that vehicle-control system 310 can interpret and execute. However, it should be understood that the functional subsystems of on-board computing system 902 may take various forms as well. Each of these example subsystems will now be described in further detail below.

For instance, the subsystems of on-board computing system 902 may begin with perception subsystem 902a, which may be configured to fuse together various different types of “raw” data that relates to the vehicle's perception of its surrounding environment and thereby derive a representation of the surrounding environment being perceived by vehicle 900. In this respect, the raw data that is used by perception subsystem 902a to derive the representation of the vehicle's surrounding environment may take any of various forms.

For instance, at a minimum, the raw data that is used by perception subsystem 902a may include multiple different types of sensor data captured by sensor system 901, such as 2D sensor data (e.g., image data) that provides a 2D representation of the vehicle's surrounding environment, 3D sensor data (e.g., LIDAR data) that provides a 3D representation of the vehicle's surrounding environment, and/or state data for vehicle 900 that indicates the past and current position, orientation, velocity, and acceleration of vehicle 900. Additionally, the raw data that is used by perception subsystem 902a may include map data associated with the vehicle's location, such as high-definition geometric and/or semantic map data, which may be preloaded onto on-board computing system 902 and/or obtained from a remote computing system. Additionally yet, the raw data that is used by perception subsystem 902a may include navigation data for vehicle 900 that indicates a specified origin and/or specified destination for vehicle 900, which may be obtained from a remote computing system (e.g., a ride-services management system) and/or input by a human riding in vehicle 900 via a user-interface component that is communicatively coupled to on-board computing system 902. Additionally still, the raw data that is used by perception subsystem 902a may include other types of data that may provide context for the vehicle's perception of its surrounding environment, such as weather data and/or traffic data, which may obtained from a remote computing system. The raw data that is used by perception subsystem 902a may include other types of data as well.

Advantageously, by fusing together multiple different types of raw data (e.g., both 2D sensor data and 3D sensor data), perception subsystem 902a is able to leverage the relative strengths of these different types of raw data in way that may produce a more accurate and precise representation of the surrounding environment being perceived by vehicle 900.

Further, the function of deriving the representation of the surrounding environment perceived by vehicle 900 using the raw data may include various aspects. For instance, one aspect of deriving the representation of the surrounding environment perceived by vehicle 900 using the raw data may involve determining a current state of vehicle 900 itself, such as a current position, a current orientation, a current velocity, and/or a current acceleration, among other possibilities. In this respect, perception subsystem 902a may also employ a localization technique such as Simultaneous Localization and Mapping (SLAM) to assist in the determination of the vehicle's current position and/or orientation. (Alternatively, it is possible that on-board computing system 902 may run a separate localization service that determines position and/or orientation values for vehicle 900 based on raw data, in which case these position and/or orientation values may serve as another input to perception subsystem 902a).

Another aspect of deriving the representation of the surrounding environment perceived by vehicle 900 using the raw data may involve detecting objects within the vehicle's surrounding environment, which may result in the determination of class labels, bounding boxes, or the like for each detected object. In this respect, the particular classes of objects that are detected by perception subsystem 902a (which may be referred to as “agents”) may take various forms, including both (i) “dynamic” objects that have the potential to move, such as vehicles, cyclists, pedestrians, and animals, among other examples, and (ii) “static” objects that generally do not have the potential to move, such as streets, curbs, lane markings, traffic lights, stop signs, and buildings, among other examples. Further, in practice, perception subsystem 902a may be configured to detect objects within the vehicle's surrounding environment using any type of object detection model now known or later developed, including but not limited object detection models based on convolutional neural networks (CNN).

Yet another aspect of deriving the representation of the surrounding environment perceived by vehicle 900 using the raw data may involve determining a current state of each object detected in the vehicle's surrounding environment, such as a current position (which could be reflected in terms of coordinates and/or in terms of a distance and direction from vehicle 900), a current orientation, a current velocity, and/or a current acceleration of each detected object, among other possibilities. In this respect, the current state each detected object may be determined either in terms of an absolute measurement system or in terms of a relative measurement system that is defined relative to a state of vehicle 900, among other possibilities.

The function of deriving the representation of the surrounding environment perceived by vehicle 900 using the raw data may include other aspects as well.

Further yet, the derived representation of the surrounding environment perceived by vehicle 900 may incorporate various different information about the surrounding environment perceived by vehicle 900, examples of which may include (i) a respective set of information for each object detected in the vehicle's surrounding, such as a class label, a bounding box, and/or state information for each detected object, (ii) a set of information for vehicle 900 itself, such as state information and/or navigation information (e.g., a specified destination), and/or (iii) other semantic information about the surrounding environment (e.g., time of day, weather conditions, traffic conditions, etc.). The derived representation of the surrounding environment perceived by vehicle 900 may incorporate other types of information about the surrounding environment perceived by vehicle 900 as well.

Still further, the derived representation of the surrounding environment perceived by vehicle 900 may be embodied in various forms. For instance, as one possibility, the derived representation of the surrounding environment perceived by vehicle 900 may be embodied in the form of a data structure that represents the surrounding environment perceived by vehicle 900, which may comprise respective data arrays (e.g., vectors) that contain information about the objects detected in the surrounding environment perceived by vehicle 900, a data array that contains information about vehicle 900, and/or one or more data arrays that contain other semantic information about the surrounding environment. Such a data structure may be referred to as a “parameter-based encoding.”

As another possibility, the derived representation of the surrounding environment perceived by vehicle 900 may be embodied in the form of a rasterized image that represents the surrounding environment perceived by vehicle 900 in the form of colored pixels. In this respect, the rasterized image may represent the surrounding environment perceived by vehicle 900 from various different visual perspectives, examples of which may include a “top down” view and a “birds eye” view of the surrounding environment, among other possibilities. Further, in the rasterized image, the objects detected in the surrounding environment of vehicle 900 (and perhaps vehicle 900 itself) could be shown as color-coded bitmasks and/or bounding boxes, among other possibilities.

The derived representation of the surrounding environment perceived by vehicle 900 may be embodied in other forms as well.

As shown, perception subsystem 902a may pass its derived representation of the vehicle's surrounding environment to prediction subsystem 902b. In turn, prediction subsystem 902b may be configured to use the derived representation of the vehicle's surrounding environment (and perhaps other data) to predict a future state of each object detected in the vehicle's surrounding environment at one or more future times (e.g., at each second over the next 5 seconds)—which may enable vehicle 900 to anticipate how the real-world objects in its surrounding environment are likely to behave in the future and then plan its behavior in a way that accounts for this future behavior.

Prediction subsystem 902b may be configured to predict various aspects of a detected object's future state, examples of which may include a predicted future position of the detected object, a predicted future orientation of the detected object, a predicted future velocity of the detected object, and/or predicted future acceleration of the detected object, among other possibilities. In this respect, if prediction subsystem 902b is configured to predict this type of future state information for a detected object at multiple future times, such a time sequence of future states may collectively define a predicted future trajectory of the detected object. Further, in some embodiments, prediction subsystem 902b could be configured to predict multiple different possibilities of future states for a detected (e.g., by predicting the 3 most-likely future trajectories of the detected object). Prediction subsystem 902b may be configured to predict other aspects of a detected object's future behavior as well.

In practice, prediction subsystem 902b may predict a future state of an object detected in the vehicle's surrounding environment in various manners, which may depend in part on the type of detected object. For instance, as one possibility, prediction subsystem 902b may predict the future state of a detected object using a data science model that is configured to (i) receive input data that includes one or more derived representations output by perception subsystem 905 at one or more perception times (e.g., the “current” perception time and perhaps also one or more prior perception times), (ii) based on an evaluation of the input data, which includes state information for the objects detected in the vehicle's surrounding environment at the one or more perception times, predict at least one likely time sequence of future states of the detected object (e.g., at least one likely future trajectory of the detected object), and (iii) output an indicator of the at least one likely time sequence of future states of the detected object. This type of data science model may be referred to herein as a “future-state model.”

Such a future-state model will typically be created by an off-board computing system (e.g., a backend platform) and then loaded onto on-board computing system 902, although it is possible that a future-state model could be created by on-board computing system 902 itself. Either way, the future-state may be created using any modeling technique now known or later developed, including but not limited to a machine-learning technique that may be used to iteratively “train” the data science model to predict a likely time sequence of future states of an object based on training data that comprises both test data (e.g., historical representations of surrounding environments at certain historical perception times) and associated ground-truth data (e.g., historical state data that indicates the actual states of objects in the surrounding environments during some window of time following the historical perception times).

Prediction subsystem 902b could predict the future state of a detected object in other manners as well. For instance, for detected objects that have been classified by perception subsystem 905 as belonging to certain classes of static objects (e.g., roads, curbs, lane markings, etc.), which generally do not have the potential to move, prediction subsystem 902b may rely on this classification as a basis for predicting that the future state of the detected object will remain the same at each of the one or more future times (in which case the state-prediction model may not be used for such detected objects). However, it should be understood that detected objects may be classified by perception subsystem 905 as belonging to other classes of static objects that have the potential to change state despite not having the potential to move, in which case prediction subsystem 902b may still use a future-state model to predict the future state of such detected objects. One example of a static object class that falls within this category is a traffic light, which generally does not have the potential to move but may nevertheless have the potential to change states (e.g. between green, yellow, and red) while being perceived by vehicle 900.

After predicting the future state of each object detected in the surrounding environment perceived by vehicle 900 at one or more future times, prediction subsystem 902b may then either incorporate this predicted state information into the previously-derived representation of the vehicle's surrounding environment (e.g., by adding data arrays to the data structure that represents the surrounding environment) or derive a separate representation of the vehicle's surrounding environment that incorporates the predicted state information for the detected objects, among other possibilities.

As shown, prediction subsystem 902b may pass the one or more derived representations of the vehicle's surrounding environment to planning subsystem 902c. In turn, planning subsystem 902c may be configured to use the one or more derived representations of the vehicle's surrounding environment (and perhaps other data) to derive a behavior plan for vehicle 900, which defines the desired driving behavior of vehicle 900 for some future period of time (e.g., the next 5 seconds).

The behavior plan that is derived for vehicle 900 may take various forms. For instance, as one possibility, the derived behavior plan for vehicle 900 may comprise a planned trajectory for vehicle 900 that specifies a planned state of vehicle 900 at each of one or more future times (e.g., each second over the next 5 seconds), where the planned state for each future time may include a planned position of vehicle 900 at the future time, a planned orientation of vehicle 900 at the future time, a planned velocity of vehicle 900 at the future time, and/or a planned acceleration of vehicle 900 (whether positive or negative) at the future time, among other possible types of state information. As another possibility, the derived behavior plan for vehicle 900 may comprise one or more planned actions that are to be performed by vehicle 900 during the future window of time, where each planned action is defined in terms of the type of action to be performed by vehicle 900 and a time and/or location at which vehicle 900 is to perform the action, among other possibilities. The derived behavior plan for vehicle 900 may define other planned aspects of the vehicle's behavior as well.

Further, in practice, planning subsystem 902c may derive the behavior plan for vehicle 900 in various manners. For instance, as one possibility, planning subsystem 902c may be configured to derive the behavior plan for vehicle 900 by (i) deriving a plurality of different “candidate” behavior plans for vehicle 900 based on the one or more derived representations of the vehicle's surrounding environment (and perhaps other data), (ii) evaluating the candidate behavior plans relative to one another (e.g., by scoring the candidate behavior plans using one or more cost functions) in order to identify which candidate behavior plan is most desirable when considering factors such as proximity to other objects, velocity, acceleration, time and/or distance to destination, road conditions, weather conditions, traffic conditions, and/or traffic laws, among other possibilities, and then (iii) selecting the candidate behavior plan identified as being most desirable as the behavior plan to use for vehicle 900. Planning subsystem 902c may derive the behavior plan for vehicle 900 in various other manners as well.

After deriving the behavior plan for vehicle 900, planning subsystem 902c may pass data indicating the derived behavior plan to control subsystem 902d. In turn, control subsystem 902d may be configured to transform the behavior plan for vehicle 900 into one or more control signals (e.g., a set of one or more command messages) for causing vehicle 900 to execute the behavior plan. For instance, based on the behavior plan for vehicle 900, control subsystem 902d may be configured to generate control signals for causing vehicle 900 to adjust its steering in a specified manner, accelerate in a specified manner, and/or brake in a specified manner, among other possibilities.

As shown, control subsystem 902d may then pass the one or more control signals for causing vehicle 900 to execute the behavior plan to vehicle-interface 902e. In turn, vehicle-interface system 902e may be configured to translate the one or more control signals into a format that can be interpreted and executed by components of vehicle-control system 310. For example, vehicle-interface system 902e may be configured to translate the one or more control signals into one or more control messages are defined according to a particular format or standard, such as a CAN bus standard and/or some other format or standard that is used by components of vehicle-control system 310.

In turn, vehicle-interface subsystem 902e may be configured to direct the one or more control signals to the appropriate control components of vehicle-control system 310. For instance, as shown, vehicle-control system 903 may include a plurality of actuators that are each configured to control a respective aspect of the vehicle's physical operation, such as a steering actuator 903a that is configured to control the vehicle components responsible for steering (not shown), an acceleration actuator 903b that is configured to control the vehicle components responsible for acceleration such as throttle (not shown), and a braking actuator 903c that is configured to control the vehicle components responsible for braking (not shown), among other possibilities. In such an arrangement, vehicle-interface subsystem 902e of on-board computing system 902 may be configured to direct steering-related control signals to steering actuator 903a, acceleration-related control signals to acceleration actuator 903b, and braking-related control signals to braking actuator 903c. However, it should be understood that the control components of vehicle-control system 903 may take various other forms as well.

Notably, the subsystems of on-board computing system 902 may be configured to perform the above functions in a repeated manner, such as many times per second, which may enable vehicle 900 to continually update both its understanding of the surrounding environment and its planned behavior within that surrounding environment.

Although not specifically shown, it should be understood that vehicle 900 includes various other systems and components as well, including but not limited to a propulsion system that is responsible for creating the force that leads to the physical movement of vehicle 900.

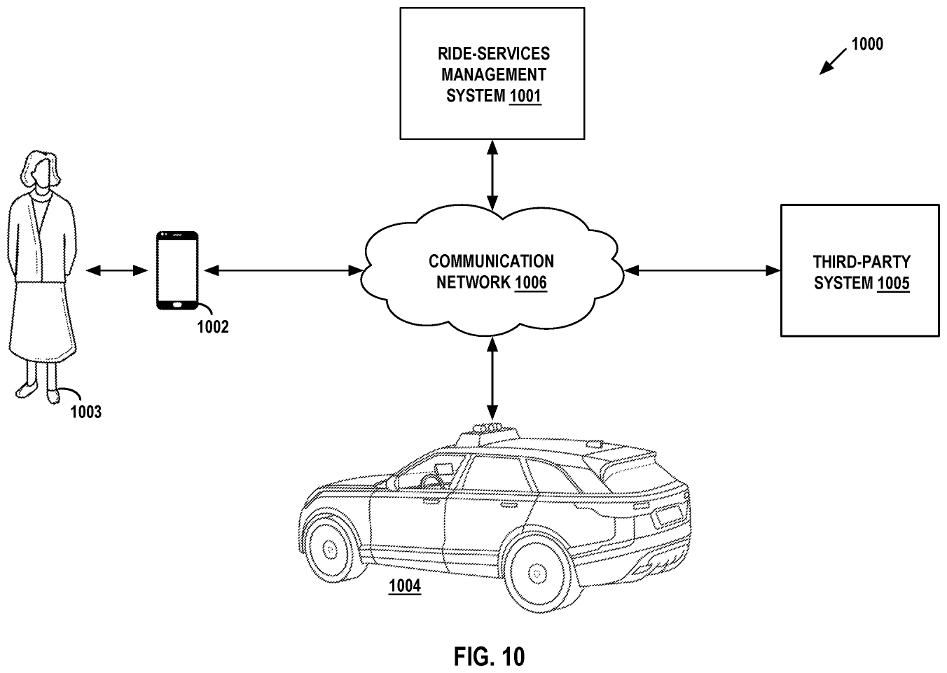

The are many use cases for the vehicles described herein, including but not limited to use cases for transportation of both human passengers and various types of goods. In this respect, one possible use case for the vehicles described herein involves a ride-services platform in which individuals interested in taking a ride from one location to another are matched with vehicles (e.g., vehicles capable of operating autonomously) that can provide the requested ride. FIG. 10 is a simplified block diagram that illustrates one example of such a ride-services platform 1000. As shown, ride-services platform 1000 may include at its core a ride-services management system 1001, which may be communicatively coupled via a communication network 1006 to (i) a plurality of client stations of individuals interested in taking rides (i.e., “ride requestors”), of which client station 1002 of ride requestor 1003 is shown as one representative example, (ii) a plurality of vehicles that are capable of providing the requested rides, of which vehicle 1004 is shown as one representative example, and (iii) a plurality of third-party systems that are capable of providing respective subservices that facilitate the platform's ride services, of which third-party system 1005 is shown as one representative example.

Broadly speaking, ride-services management system 1001 may include one or more computing systems that collectively comprise a communication interface, at least one processor, data storage, and executable program instructions for carrying out functions related to managing and facilitating ride services. These one or more computing systems may take various forms and be arranged in various manners. For instance, as one possibility, ride-services management system 1001 may comprise computing infrastructure of a public, private, and/or hybrid cloud (e.g., computing and/or storage clusters). In this respect, the entity that owns and operates ride-services management system 1001 may either supply its own cloud infrastructure or may obtain the cloud infrastructure from a third-party provider of “on demand” computing resources, such as AWS, Microsoft Azure, Google Cloud, Alibaba Cloud, or the like. As another possibility, ride-services management system 1001 may comprise one or more dedicated servers. Other implementations of ride-services management system 1001 are possible as well.

As noted, ride-services management system 1001 may be configured to perform functions related to managing and facilitating ride services, which may take various forms. For instance, as one possibility, ride-services management system 1001 may be configured to receive ride requests from client stations of ride requestors (e.g., client station 1002 of ride requestor 1003) and then fulfill such ride requests by dispatching suitable vehicles, which may include vehicles such as vehicle 1004. In this respect, a ride request from client station 1002 of ride requestor 1003 may include various types of information.

For example, a ride request from client station 1002 of ride requestor 1003 may include specified pick-up and drop-off locations for the ride. As another example, a ride request from client station 1002 of ride requestor 1003 may include an identifier that identifies ride requestor 1003 in ride-services management system 1001, which may be used by ride-services management system 1001 to access information about ride requestor 1003 (e.g., profile information) that is stored in one or more data stores of ride-services management system 1001 (e.g., a relational database system), in accordance with the ride requestor's privacy settings. This ride requestor information may take various forms, examples of which include profile information about ride requestor 1003. As yet another example, a ride request from client station 1002 of ride requestor 1003 may include preferences information for ride requestor 1003, examples of which may include vehicle-operation preferences (e.g., safety comfort level, preferred speed, rates of acceleration or deceleration, safety distance from other vehicles when traveling at various speeds, route, etc.), entertainment preferences (e.g., preferred music genre or playlist, audio volume, display brightness, etc.), temperature preferences, and/or any other suitable information.

As another possibility, ride-services management system 1001 may be configured to access ride information related to a requested ride, examples of which may include information about locations related to the ride, traffic data, route options, optimal pick-up or drop-off locations for the ride, and/or any other suitable information associated with a ride. As an example and not by way of limitation, when ride-services management system 1001 receives a request to ride from San Francisco International Airport (SFO) to Palo Alto, Calif., system 1001 may access or generate any relevant ride information for this particular ride request, which may include preferred pick-up locations at SFO, alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason, one or more routes to travel from SFO to Palo Alto, preferred off-ramps for a type of ride requestor, and/or any other suitable information associated with the ride.

In some embodiments, portions of the accessed ride information could also be based on historical data associated with historical rides facilitated by ride-services management system 1001. For example, historical data may include aggregate information generated based on past ride information, which may include any ride information described herein and/or other data collected by sensors affixed to or otherwise located within vehicles (including sensors of other computing devices that are located in the vehicles such as client stations). Such historical data may be associated with a particular ride requestor (e.g., the particular ride requestor's preferences, common routes, etc.), a category/class of ride requestors (e.g., based on demographics), and/or all ride requestors of ride-services management system 1001.

For example, historical data specific to a single ride requestor may include information about past rides that a particular ride requestor has taken, including the locations at which the ride requestor is picked up and dropped off, music the ride requestor likes to listen to, traffic information associated with the rides, time of day the ride requestor most often rides, and any other suitable information specific to the ride requestor. As another example, historical data associated with a category/class of ride requestors may include common or popular ride preferences of ride requestors in that category/class, such as teenagers preferring pop music, ride requestors who frequently commute to the financial district may prefer to listen to the news, etc. As yet another example, historical data associated with all ride requestors may include general usage trends, such as traffic and ride patterns.

Using such historical data, ride-services management system 1001 could be configured to predict and provide ride suggestions in response to a ride request. For instance, ride-services management system 1001 may be configured to apply one or more machine-learning techniques to such historical data in order to “train” a machine-learning model to predict ride suggestions for a ride request. In this respect, the one or more machine-learning techniques used to train such a machine-learning model may take any of various forms, examples of which may include a regression technique, a neural-network technique, a kNN technique, a decision-tree technique, a SVM technique, a Bayesian technique, an ensemble technique, a clustering technique, an association-rule-learning technique, and/or a dimensionality-reduction technique, among other possibilities.

In operation, ride-services management system 1001 may only be capable of storing and later accessing historical data for a given ride requestor if the given ride requestor previously decided to “opt-in” to having such information stored. In this respect, ride-services management system 1001 may maintain respective privacy settings for each ride requestor that uses ride-services platform 1000 and operate in accordance with these settings. For instance, if a given ride requestor did not opt-in to having his or her information stored, then ride-services management system 1001 may forgo performing any of the above-mentioned functions based on historical data. Other possibilities also exist.

Ride-services management system 1001 may be configured to perform various other functions related to managing and facilitating ride services as well.

Referring again to FIG. 10, client station 1002 of ride requestor 1003 may generally comprise any computing device that is configured to facilitate interaction between ride requestor 1003 and ride-services management system 1001. For instance, client station 1002 may take the form of a smartphone, a tablet, a desktop computer, a laptop, a netbook, and/or a PDA, among other possibilities. Each such device may comprise an I/O interface, a communication interface, a GNSS unit such as a GPS unit, at least one processor, data storage, and executable program instructions for facilitating interaction between ride requestor 1003 and ride-services management system 1001 (which may be embodied in the form of a software application, such as a mobile application, web application, or the like). In this respect, the interaction that may take place between ride requestor 1003 and ride-services management system 1001 may take various forms, representative examples of which may include requests by ride requestor 1003 for new rides, confirmations by ride-services management system 1001 that ride requestor 1003 has been matched with a vehicle (e.g., vehicle 1004), and updates by ride-services management system 1001 regarding the progress of the ride, among other possibilities.

In turn, vehicle 1004 may generally comprise any vehicle that is equipped with autonomous technology, and in one example, may take the form of vehicle 900 described above. Further, the functionality carried out by vehicle 1004 as part of ride-services platform 1000 may take various forms, representative examples of which may include receiving a request from ride-services management system 1001 to handle a new ride, autonomously driving to a specified pickup location for a ride, autonomously driving from a specified pickup location to a specified drop-off location for a ride, and providing updates regarding the progress of a ride to ride-services management system 1001, among other possibilities.

Generally speaking, third-party system 1005 may include one or more computing systems that collectively comprise a communication interface, at least one processor, data storage, and executable program instructions for carrying out functions related to a third-party subservice that facilitates the platform's ride services. These one or more computing systems may take various forms and may be arranged in various manners, such as any one of the forms and/or arrangements discussed above with reference to ride-services management system 1001.

Moreover, third-party system 1005 may be configured to perform functions related to various subservices. For instance, as one possibility, third-party system 1005 may be configured to monitor traffic conditions and provide traffic data to ride-services management system 1001 and/or vehicle 1004, which may be used for a variety of purposes. For example, ride-services management system 1001 may use such data to facilitate fulfilling ride requests in the first instance and/or updating the progress of initiated rides, and vehicle 1004 may use such data to facilitate updating certain predictions regarding perceived agents and/or the vehicle's behavior plan, among other possibilities.

As another possibility, third-party system 1005 may be configured to monitor weather conditions and provide weather data to ride-services management system 1001 and/or vehicle 1004, which may be used for a variety of purposes. For example, ride-services management system 1001 may use such data to facilitate fulfilling ride requests in the first instance and/or updating the progress of initiated rides, and vehicle 1004 may use such data to facilitate updating certain predictions regarding perceived agents and/or the vehicle's behavior plan, among other possibilities.

As yet another possibility, third-party system 1005 may be configured to authorize and process electronic payments for ride requests. For example, after ride requestor 1003 submits a request for a new ride via client station 1002, third-party system 1005 may be configured to confirm that an electronic payment method for ride requestor 1003 is valid and authorized and then inform ride-services management system 1001 of this confirmation, which may cause ride-services management system 1001 to dispatch vehicle 1004 to pick up ride requestor 1003. After receiving a notification that the ride is complete, third-party system 1005 may then charge the authorized electronic payment method for ride requestor 1003 according to the fare for the ride. Other possibilities also exist.

Third-party system 1005 may be configured to perform various other functions related to subservices that facilitate the platform's ride services as well. It should be understood that, although certain functions were discussed as being performed by third-party system 1005, some or all of these functions may instead be performed by ride-services management system 1001.

As discussed above, ride-services management system 1001 may be communicatively coupled to client station 1002, vehicle 1004, and third-party system 1005 via communication network 1006, which may take various forms. For instance, at a high level, communication network 1006 may include one or more WANs (e.g., the Internet or a cellular network), LANs, and/or PANs, among other possibilities, where each such network which may be wired and/or wireless and may carry data according to any of various different communication protocols. Further, it should be understood that the respective communications paths between the various entities of FIG. 10 may take other forms as well, including the possibility that such communication paths include communication links and/or intermediate devices that are not shown.

In the foregoing arrangement, client station 1002, vehicle 1004, and/or third-party system 1005 may also be capable of indirectly communicating with one another via ride-services management system 1001. Additionally, although not shown, it is possible that client station 1002, vehicle 1004, and/or third-party system 1005 may be configured to communicate directly with one another as well (e.g., via a short-range wireless communication path or the like). Further, vehicle 1004 may also include a user-interface system that may facilitate direct interaction between ride requestor 1003 and vehicle 1004 once ride requestor 1003 enters vehicle 1004 and the ride begins.

It should be understood that ride-services platform 1000 may include various other entities and various other forms as well.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and sprit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

What is claimed is:

1. A computer-implemented method comprising:
generating a set of candidate trajectories for a vehicle, wherein each candidate trajectory of the set of candidate trajectories comprises a series of planned states for the vehicle;
scoring the candidate trajectories in the generated set of candidate trajectories using one or more reference models that are each configured to (i) receive input values for a respective set of feature variables that are correlated to a respective scoring parameter and (ii) output a value for the respective scoring parameter that is reflective of human-driving behavior;
based at least in part on the scoring, selecting a candidate trajectory from the generated set of candidate trajectories to serve as a planned trajectory for vehicle; and
using the selected candidate trajectory as the planned trajectory for the vehicle.

2. The computer-implemented method of claim 1, wherein scoring a respective candidate trajectory in the generated set of candidate trajectories comprises:
determining expected values for one or more scoring parameters at a plurality of time points along the respective candidate trajectory;
determining idealized values for the one or more scoring parameters at the plurality of time points along the respective candidate trajectory, wherein the one or more reference models are used for the determining of the idealized values for the one or more scoring parameters;
evaluating an extent to which the expected values for the one or more scoring parameters differ from the idealized values for one or more scoring parameters; and
based on the evaluation of the extent to which the expected values for the one or more scoring parameters differ from the idealized values for the one or more scoring parameters, assigning a respective score to the respective candidate trajectory.

3. The computer-implemented method of claim 2, wherein evaluating the extent to which the expected values for the one or more scoring parameters differ from the idealized values for the one or more scoring parameters comprises using one or more cost functions to determine a cost value associated with a difference between the expected values for the one or more scoring parameters and the idealized values for the one or more scoring parameters.

4. The computer-implemented method of claim 2, wherein the one or more scoring parameters are selected based on a scenario type that is being experienced by the vehicle.

5. The computer-implemented method of claim 1, the method further comprising:
before scoring each candidate trajectory in the generated set of candidate trajectories using the one or more reference models, (i) determining a scenario type that is being experienced by the vehicle and (ii) using the determined scenario type as a basis for selecting the one or more reference models that are used for the scoring.

6. The computer-implemented method of claim 1, wherein each respective reference model of the one or more reference models was built from data indicative of observed behavior of vehicles being driven by humans.

7. The computer-implemented method of claim 6, wherein each respective reference model of the one or more reference models was previously built by (i) collecting the data indicative of the observed behavior of the vehicles being driven by humans, (ii) extracting model data for building the respective reference model from the collected data, wherein the extracted model data includes (a) values for the respective scoring parameter that were captured for the vehicles being driven by humans at various past times and (b) corresponding values for the respective set of feature variables that were also captured for the vehicles being driven by humans at the past times, and (iii) building the respective reference model from the extracted model data.

8. The computer-implemented method of claim 7, wherein building the respective reference model from the extracted model data comprises embodying the extracted model data into a lookup table having dimensions defined by the respective set of feature variables and cells that are encoded with idealized values for the respective scoring parameter.

9. The computer-implemented method of claim 7, wherein building the respective reference model from the extracted model data comprises using one or more machine learning techniques to train a machine-learning model based on the extracted model data.

10. The computer-implemented method of claim 1, wherein the one or more reference models comprise at least one blended model that is configured to select between an output of a first sub-model that is reflective of human-driving behavior and an output of a second sub-model that is not reflective of human-driving behavior.

11. A non-transitory computer-readable medium comprising program instructions stored thereon that are executable to cause a computing system to:
generate a set of candidate trajectories for a vehicle, wherein each candidate trajectory of the set of candidate trajectories comprises a series of planned states for the vehicle;
score the candidate trajectories in the generated set of candidate trajectories using one or more reference models that are each configured to (i) receive input values for a respective set of feature variables that are correlated to a respective scoring parameter and (ii) output a value for the respective scoring parameter that is reflective of human-driving behavior;
based at least in part on the scoring, selected a candidate trajectory from the generated set of candidate trajectories to serve as a planned trajectory for the vehicle; and
use the selected candidate trajectory as the planned trajectory for vehicle.

12. The computer-readable medium of claim 11, wherein the program instructions that are executable to cause the computing system to score a respective candidate trajectory in the generated set of candidate trajectories comprise program instructions that are executable to cause the computing system to:
determine expected values for one or more scoring parameters at a plurality of time points along the respective candidate trajectory;
determine idealized values for the one or more scoring parameters at the plurality of time points along the respective candidate trajectory, wherein the one or more reference models are used for the determining of the idealized values for the one or more of the scoring parameters;
evaluate an extent to which the expected values for the one or more scoring parameters differ from the idealized values for the one or more scoring parameters; and
based on the evaluation of the extent to which the expected values for the one or more scoring parameters differ from the idealized values for the one or more scoring parameters, assign a respective score to the respective candidate trajectory.

13. The computer-readable medium of claim 12, wherein the program instructions that are executable to cause the computing system to evaluate an extent to which the expected values for the one or more scoring parameters differ from the idealized values for the one or more scoring parameters comprise program instructions that are executable to cause the computing system to use one or more cost functions to determine a cost value associated with a difference between the expected values for the one or more scoring parameters and the idealized values for the one or more scoring parameters.

14. The computer-readable medium of claim 11, wherein each respective reference model of the one or more reference models was built from data indicative of observed behavior of vehicles being driven by humans.

15. The computer-readable medium of claim 14, wherein each respective reference model of the one or more reference models was previously built by (i) collecting the data indicative of the observed behavior of the vehicles being driven by humans, (ii) extracting model data for building the respective reference model from the collected data, wherein the extracted model data includes (a) values for the given scoring parameter that were captured for the vehicles being driven by humans at various past times and (b) corresponding values for the respective set of feature variables that were also captured for the vehicles being driven by humans at the past times, and (iii) building the respective reference model from the extracted model data.

16. The computer-readable medium of claim 15, wherein building the respective reference model from the extracted model data comprises embodying the extracted model data into a lookup table having dimensions defined by the respective set of feature variables and cells that are encoded with idealized values for the respective scoring parameter.

17. The computer-readable medium of claim 15, wherein building the respective reference model from the extracted model data comprises using one or more machine learning techniques to train a machine-learning model based on the extracted model data.

18. The computer-readable medium of claim 11, wherein the one or more reference models comprise at least one blended model that is configured to select between an output of a first sub-model that is reflective of human-driving behavior and an output of a second sub-model that is not reflective of human-driving behavior.

19. A computing system comprising:
at least one processor;
a non-transitory computer-readable medium; and
program instructions stored on the non-transitory computer-readable medium that are executable by the at least one processor such that the computing system is configured to:
generate a set of candidate trajectories for a vehicle, wherein each candidate trajectory of the set of candidate trajectories comprises a series of planned states for the vehicle;
score the candidate trajectories in the generated set of candidate trajectories using one or more reference models that are each configured to (i) receive input values for a respective set of feature variables that are correlated to a respective scoring parameter and (ii) output a value for the respective scoring parameter that is reflective of human-driving behavior;
based at least in part on the scoring, select a candidate trajectory from the generated set of candidate trajectories to serve as a planned trajectory for vehicle; and
use the selected candidate trajectory as the planned trajectory for the vehicle.

20. The computing system of claim 19, wherein the program instructions that are executable by the at least one processor such that the computing system is configured to score a respective candidate trajectory in the generated set of candidate trajectories comprise program instructions that are executable by the at least one processor such that the computing system is configured to:
determine expected values for one or more scoring parameters at a plurality of time points along the respective candidate trajectory;
determine idealized values for the one or more scoring parameters at the plurality of time points along the respective candidate trajectory, wherein the one or more reference models are used for the determining of the idealized values for the one or more of the scoring parameters;
evaluate an extent to which the expected values for the one or more scoring parameters differ from the idealized values for the one or more scoring parameters; and
based on the evaluation of the extent to which the expected values for the one or more scoring parameters differ from the idealized values for the one or more scoring parameters, assign a respective score to the respective candidate trajectory.
